(19) United States
(12) Patent Application Publication
(10) Pub. No.: US 2008/0086359 A1
(43) Pub. Date: Apr. 10, 2008

(54) SALES OPPORTUNITY EXPLORER

(76) Inventors: Peter R. Holton, Stamford, CT (US); Richard J. Rauch, Broomall, PA (US); Jeffrey John Mueller, Tonawanda, NY (US); Patrick James McBride, Ellicott City, MD (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/866,321

(22) Filed: Oct. 2, 2007

Related U.S. Application Data
(60) Provisional application No. 60/828,181, filed on Oct. 4, 2006.

(51) Int. Cl. G06Q 10/00; G06F 17/30; G06Q 30/00; G06F 17/40

(52) U.S. Cl. 705/10; 705/7

(57) ABSTRACT

An interactive software tool processes accumulated point of sale consumption data so as to identify where sales problems and opportunities lie. Once identified, appropriate resources can then be deployed to fix the problem and to realize the opportunities so identified. The interactive software tool is designed to permit a user to speedily have insight into sales patterns across multiple categories of goods and retailers. The tool can be particularly focused on brands and specific types of business. The tool has an interactive user interface that allows its user to quickly see identified business performance alerts. In sum, the interactive software tool permits a rapid assessment of where a sales and marketing team should apply their efforts and resources so as to efficiently deploy appropriate resources to fix sales problems and to realize sales opportunities that have been identified with the interactive software tool.

### RELATED APPLICATIONS

This application claims priority to and the benefit of U.S. Provisional Application Ser. No. 60/828,181, filed on Oct. 4, 2006, titled “Sales Opportunity Explorer”, the entire contents of which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### TECHNICAL FIELD

The present invention relates generally to sales and marketing, and more specifically to software tools to enhance sales and marketing.

### BACKGROUND

A general practice of retailers, particularly supermarkets and drug stores, is to collect point of sale data. These retailers often issue affinity or loyalty cards to better track their customers' buying habits and trends. These data can then be used to understand sales and marketing by the retailer.

One way for the retailer to acquire point of sale data is through the use of an optical scanner at the point of sale (e.g.; at a cash register). The retailer can then sell the data that has been captured to a consumer data organization, such as Information Resources, Inc. or A. C. Nielsen. The consumer data organizations then cleanse, scrub, and organize the consumer data for resale back to retailers, manufacturers, and others who may benefit from analyzing these consumption data. For instance, these data may be useful to a consumer packaged good company like Pepsico, Unilever, Master Foods, Johnson & Johnson, Del Monte, Georgia Pacific, etc.

A problem with the present tools for analysis of consumption data is that summaries of the same are not easily grouped for quick visual assessments across all the categories and brands of consumer products, thereby precluding any quick identification of sales opportunities that had been missed or that are emerging. Another problem is that sales opportunities that can be gleaned from consumption data cannot be proactively tracked and communicated. Moreover, conventional consumption data analysis tools do not provide clear direction and insight on business opportunities to marketing organizations that are responsible for capitalizing upon sales opportunities.

Still further, conventional consumption data analysis tools are not structured to look across multiple categories of goods at multiple retailers, and thus a user of these tools must make a series of ad hoc queries when seeking to answer key business questions, such as whether a particular manufacturer's brand is declining as compared to a prior year, whether a particular manufacturer's brand sales are underperforming within its category and/or product segment; whether a particular manufacturer's brand has an opportunity gap at one or more retailers, and whether a particular manufacturer's brand share in the market is declining as compared to a prior time period. Accordingly, it would be an advance in the art to provide an interactive tool that is dimensionalized to analyze accumulated consumption data across multiple categories of goods at multiple retailers in order to identify where significant sales issues and sales opportunities can be found so that resources can then be efficiently deployed to respectively correct these identified issues and/or to realize these identified opportunities.

### BRIEF DESCRIPTION OF THE DRAWINGS

FIGS. 1-34 are full and partial views of exemplary user interface screens for a Sales Opportunity Explorer tool as described with respect to various implementations thereof.

### SUMMARY

An interactive software tool processes accumulated point of sale consumption data so as to identify where sales problems and opportunities lie. Once identified, appropriate resources can then be deployed to fix the problems and to realize the opportunities so identified. The interactive software tool is designed to permit a user to speedily have insight into sales patterns across multiple categories of goods and retailers. The tool can be particularly focused on brands and specific types of business. The tool has an interactive user interface that allows its user to quickly see identified business performance alerts. In sum, the interactive software tool permits a rapid assessment of where a sales and marketing team should apply their efforts and resources so as to efficiently deploy appropriate resources to fix sales problems and to realize sales opportunities that have been identified with the interactive software tool.

The interactive software tool to selectively process accumulated point of sale consumption data and display particularly formatted results of such processing is referred to herein as “The Sales Opportunity Explorer Tool”, or SOE Tool. The SOE Tool can be used to show key business performance alerts. For instance, four (4) such alerts identify the following opportunities and issues:
(i) Whether a brand's sales are declining with respect to a prior time period;
(ii) Whether a brand's share of the market is declining with respect to a prior time period;
(iii) Whether a brand's sales growth is not keeping up with its corresponding goods category of growth, or whether the brand's sales are underperforming in the corresponding goods category or segment of the market; and
(iv) Whether a brand has a sales opportunity gap at one or more retailers (e.g.; whether the brand's provider is getting its fair share of market sales).

The SOE Tool can be used to apply filtering and sorting on unique views that alert and provide visual and/or audio cues (e.g.; indicators) as to sales opportunities. For instance, these cues can be provided via different alert identifications that enable significant speed to insight as to significant sales issues/problems and sales opportunities otherwise not available in conventional data tools. The SOE Tool functionality includes a ‘dashboard’ for visual user experience that includes the accumulation and quantification of alerts, in the form of various audio and/or visual cues that can be seen rapidly at a glance. By way of example, colors and/or shading can be used to alternatively emphasize and deemphasize certain opportunities and certain problems.

The SOE Tool makes an organized presentation of sales components through a sequence of the views for a desired work flow process. This work flow process progressively enlightens the viewer and concludes with a final view that is a composite of the different elements of the whole process. With understanding of these views, the viewer can then proactively add comments into the data of the SOE Tool that are stored in a data base for the SOE Tool. Reports can be generated automatically and upon demand for delivery to decision makers (e.g.; field personnel) who will be inspired to undertake activities that solve sales issues/problems and act upon sales opportunities as are indicated by the reports.

### DETAILED DESCRIPTION

An interactive software tool is described. This tool selectively processes accumulated consumption data and displays particularly formatted results of such processing. The tool is referred to herein as “The Sales Opportunity Explorer Tool”, or SOE Tool. The SOE Tool is a business intelligence software application that drives a business discovery process designed to deliver performance insights across a selected portfolio of categories and retailers.

The accumulated consumption data used by the SOE Tool can be acquired from a single data set or it can be derived from a combination of data sets. One such data set is a collection of Point of Sale (POS) records obtained from retailers at a check-out line, a point of sale terminal, a point of service location, or from other sales accumulation functionality units. It can be deduced from this accumulated data set how of a much a category-brand-item was consumed within a given period of time.

Another data set that can be used by the SOE Tool is retail audit data (RAD). A RAD data set is collected using hand-held scanners by personnel who visit retail stores to determine inventory levels (including “out-of-stock” conditions) and related information regarding products that are actually available to purchase.

Another data set that can be used by the SOE Tool is Consumer Panel Data (CPD) that is gathered from a plurality of households in which scanners have been installed for use by the household's residents. As such, the cooperating residents scan in data for all of the products that they purchase. These data, in the aggregate, provide information on product loyalties, buying patterns, etc. across a variety of selected product consuming households on their respective purchases over time.

Although the data sets of POS, RAD, and CPD can be used by the SOE Tool both alone and in combination, other consumption data sets can also be used by the SOE Tool.

As used herein a retailer is a place where a point of sale takes place, particularly of a retail purchase of a consumer packaged good. For instance, retailers include drug stores and food stores. By way of example, a category might be ‘frozen pizza’. Three (3) segments within the frozen pizza category might be premium, value frozen pizza, and microwave frozen pizza. As such, a segment is a smaller component of a larger category. Hierarchically, the category is at the top, the segment is in the middle, and the brand is at the bottom. Within the brand are found various items (e.g.; Acme cheese pizza, Acme pepperoni pizza). For the purposes of this document, the SOE Tool will be described to the brand level, not down to the item level, although the SOE Tool operates down to the item category-brand-item level.

The SOE Tool provides alerts to its user in four (4) areas, referred to herein as the Four Metrics. In one implementation, the Four Metrics can be expressed as:
1) Whether a brand's sales are declining with respect to a prior time period, or whether a particular manufacturer's category-brand is declining as compared to a prior year;
2) Whether a brand's market share is declining with respect to a prior time period, or whether a particular manufacturer's category-brand market share is declining as compared to a prior time period;
3) Whether a category-brand's sales growth is not keeping up with its corresponding goods category of growth, or whether the category-brand's sales are underperforming in the corresponding goods category or segment of the market; and
4) Whether a category-brand has a sales opportunity gap at one or more retailers (e.g.; whether the category-brand's provider is getting its fair share of the sales in the market), or whether a particular manufacturer's category-brand has an opportunity gap at one or more retailers.

The work flow of the SOE Tool is designed around a discovery process that leads a business manager to “speed to insight” through a process of expressed sales analytics. This process culminates into presentation deployable content for field communication that stimulates proactive action against the business revelations. The expression of this business process, in both form and function, enables a company to understand their product(s) sales performance. It provides a mechanism to review this performance across a variable number of categories, segments or brands. The SOE Tool provides an understanding of sales performance insights simultaneously for multiple retailer customers, enabling a user with opportunity identification and retailer performance benchmarking.

In one implementation, the Four Metrics can be used by the SOE Tool in the following steps:

(i) average the decline in sales of a category-brand for those retailers that have declining sales for that category-brand, and define this average as a benchmark. Each benchmark can be dynamically refreshed based on the then-current data in the selected categories each time that the SOE Tool is accessed; and

(ii) for each retailer having a decline in sales of the category-brand:
1 compare that retailer's decline with the computed benchmark;
2 determine if the retailers' decline in sales exceeds the computed benchmark for sales decline;
3 If the computed benchmark is exceeded, quantify the deviation;
4 Lookup an alert corresponding to the quantified deviation; and
5 Render the alert corresponding to the quantified deviation, where the rendering can be visual and/or audible and can be upon an interactive display, screen, a printed report, etc.

In this implementation, there can be renderings of audible and/or visual alerts for respective deviations over the dynamically computed category benchmarks. Stated otherwise, there can be multiple deviation thresholds for multiple alerts, where each alert is particularized to one or more different states of urgency. The alerts can be transmitted locally or remotely, upon demand. As such, business metrics that are lagging an identified benchmark will be interpreted by the SOE Tool to represent a condition that triggers an alert. The alert can then be communicated by the SOE Tool in its particularized urgency to the SOE Tool user or other business manager.

Alerts can be depicted graphically for various chronologies and rankings, such as for a current time-period vs. a past time period, with a showing of the bottom and top 10 retailers for dollar volume change (growth/decline) percent change and dollar market share change (growth/decline). By combining multiple alerts derived from the calculations of the Four Metrics, the SOE Tool enables the user to identify and prioritize the sales problems and sales opportunities according to their urgency and potential value.

In another implementation, an initial view of an alert can be triggered by the existence of a condition that is detected from the Four Metrics can be used by the SOE Tool, where the alert will be triggered even if it is minor or seemingly insignificant. In this implementation, the magnitude of the deviation does not matter. So in the “Decline in Sales” Metric, if this year's sales are $1 less than last year's sales, an alert is issued.

On a subsequent ‘Topline’ detailed review, the alert conditions are presented with an additional intensity if the condition is greater then the average for all selected retailers with an alert condition. Also, each alert condition is graphed in other views across selected retailers so the magnitude or significance of the alert condition is expressed visually. For example, a table look-up can be used to determine the appropriate visual cue based on deviation from a normal, standard, or predetermined comparison value.

In yet another implementation, the Four (4) Metrics used by the SOE Tool can be understood, respectively, as (i) The “Decline in Sales” Metric; (ii) The “Decline in Brand Share” Metric; (iii) The “Underperforming Category Metric; and (iv) “Sales Opportunity Gap” Metric. These Four Metrics can be derived, respectively, as follows:

(i) For the “Decline in Sales” Metric, compare:
a. the category-brand's dollar sales in a selected time period; and
b. the category-brand's dollar sales in a corresponding prior time period (e.g., this year vs. last year).

If the dollar sales for the category-brand have declined, an alert is issued.

(ii) For the “Decline in Brand Share” Metric, compare:
a. the category-brand's market share of the overall category in a selected time period; and
b. the category-brand's market share of the overall category in a corresponding prior time period.

If market share for the category-brand has declined, an alert is issued.

(iii) For the “Underperforming Category Metric, compare:
a. the category-brand's percent growth in dollar sales in a selected time period; and
b. the percent growth in dollar sales for the overall category in the same time period.
If the category-brand's percent growth is less than the overall category's percent growth, an alert is issued.

(iv) For the “Sales Opportunity Gap” Metric, compare:
a. the category-brand's market share at a given retailer in a selected time period; and
b. the category-brand's market share of the overall category in the same time period.
If the category-brand's market share at the retailer is less than the category-brand's market share of the overall category, an alert is issued.

As referred to herein, market share can be a category-brand's share of the total sales of all products within the category in which that brand competes. The SOE Tool dynamically calculates market share by dividing a category-brand's sales volume by the total category sales volume for the specified time periods. Stated otherwise, market share is the percentage of sales, in terms of dollars or units, obtained by the category-brand in a given market of all category-brands out of the whole as a result of a variety of factors, including but not limited to success in marketing effectiveness, product characteristics, pricing, cost, delivery time, and quality. Market share is affected by the type of industry and number of competitors, and can indicate the stage of a product's life cycle (introduction, growth, maturity, decline).

In addition to overall market share, the SOE Tool also calculates market share for the specified time periods at specified retailers in order to identify a ‘sales opportunity gap’. In one implementation, the sales opportunity gap is a calculation of the dollar opportunity at a particular retailer for a category-brand, where if the retailer had sales of a category-brand that are less than the sales that would be expected if that category-brand achieved its “fair share” of the sales in that category at that retailer, that is if the market share for that category-brand at the specified retailer is less than the overall market share of that category-brand in that category for competitive retailers, then the difference in the dollar value of sales for that category-brand between the actual level of sales of that category-brand at that retailer and what should be expected to be sold at that retailer, is the sales opportunity gap at that retailer. The sales opportunity gap can take several different expressions, such as the retailer category-brand sales last year versus all of the sales of the category-brand at all retailers last year (that is, as measured against that retailer's ‘rest of market’). Stated otherwise, the sales opportunity gap could be stated as the sales performance of a category-brand versus the sales of that category-brand for the total market.

In a still further implementation, the Four Metrics can be used by the SOE Tool in the following steps A through E.

A. For each for a plurality of criteria within each of a plurality of retailers, wherein the criteria can be one or more brands, segments having a plurality of the brands, and categories having a plurality the segments, calculating:
the currency value of sales for the criteria at the retailer for a current time period;

the currency value of sales for the criteria at the retailer for a past time period;
the difference in the currency value of sales for the criteria at the retailer between the current and past time periods;

and

for each retailer showing a decline in the currency value of sales for the criteria, rendering a first alert.

B. For each for a plurality of criteria within each of a plurality of retailers, wherein the criteria is selected from the group consisting of brands, segments having a plurality of said brands, and categories having a plurality said segments, calculating:
the percentage change in the currency value of sales for the criteria at the retailer for a current time period as compared with a past time period;
the percentage change in the currency value of sales for the criteria at the retailer for the current time period as compared with the past time period;
the difference between the percentage growth change of sales for the criteria at the retailer and the percentage growth change of sales for the criteria for the plurality of said retailers;

and

for each said retailer whose percentage growth change of sales for the criteria is lower than the percentage growth change of sales for the criteria at the plurality of said retailers, rendering a second alert.

C. For each for a plurality of criteria within each of a plurality of retailers, wherein the criteria is selected from the group consisting of brands, segments having a plurality of said brands, and categories having a plurality said segments, calculating:
the market share of the currency value of sales for the criteria at the retailer as compared with the currency value of sales for the entire market for the criteria at the plurality of said retailers for a current time period;
the market share of the currency value of sales for the criteria at the retailer as compared with the currency value of sales for the entire market for the criteria at the plurality of said retailers for a past time period; and
the difference in the market share of the currency value of sales for the criteria at the retailer between the current and past time periods;

and

for each said retailer showing a decline in the market share of the currency value of sales for the criteria, rendering a third alert.

D. For each for a plurality of criteria within each of a plurality of retailers, wherein the criteria is selected from the group consisting of brands, segments having a plurality of said brands, and categories having a plurality said segments, calculating:
the actual currency value of sales for the criteria at the retailer for a time period;
the expected currency value of sales for the criteria at the retailer for the time period that would be achieved if the market share for the criteria at the retailer was equal to the overall market share for the criteria at all said retailers;
the difference, being a sales opportunity gap amount, between the actual currency value of sales for the criteria at the retailer and the expected currency value of sales for the criteria at the retailer;

and

for each said retailer where the actual currency value of sales for the criteria is less than the expected currency value of sales for the criteria, rendering a fourth alert.

E. For each of the retailers, ranking the corresponding number of each said first, second, third, and fourth alerts, and rendering the ranked alerts.

In one implementation, the SOE Tool consists of eight (8) components with a defined workflow to speed and facilitate insight analysis:

1. Performance Alerts View

2. Alerts Scorecard View

3. Sales Topline View

4. Sales Growth View

5. Sales Share & Change View

6. Sales Opportunity Gap View

7. Performance Detail View

8. Total U.S. View

The SOE Tool provides end users with robust reporting capabilities to facilitate and automate the communication and distribution of the identified business insights. End users are enabled to identify action against opportunities and can input and store these analysis observations and recommended action steps for communication and deployment to business associates and partners. The core data source for the application is POS (Point of Sale) or sales data utilizing universally accepted sales performance metrics. As a result, the SOE Tool provides a combination of designed and developed elements as follows:

Custom data structure design

Extended data attributes, measures and dimensions

Business alerts metrics

Application component design, layout and functionality

Business analysis workflow process

Comprehensive interactive reporting and communication capabilities

This SOE Tool's approach provides “speed to insight” for business management, and enables companies to quickly identify brands with significant sales issues or opportunities for growth and proactively react to each issue.

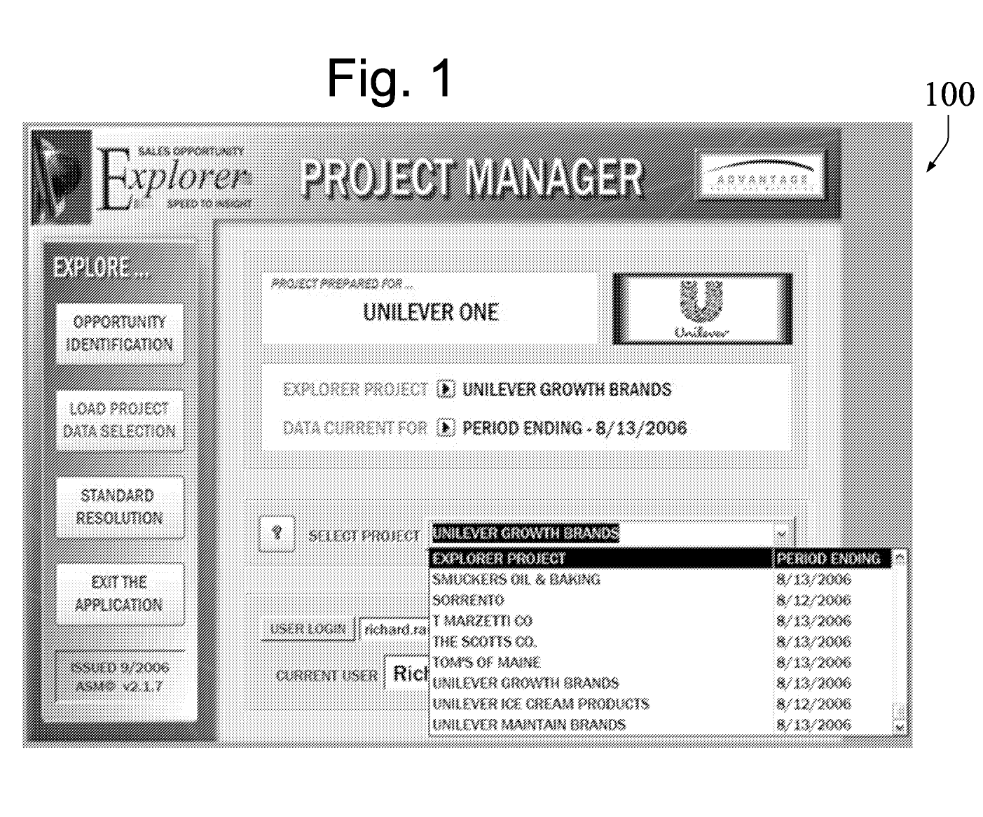

Referring now to FIG. 1, an exemplary screen shot for the SOE Tool is generally depicted at 100, titled “EXPLORER PROJECT MANAGER”. The Explorer Project Manager 100 provides one of the gateways into the SOE Tool. Moreover, it allows a user to login and authenticate to the SOE Tool's system's authorization and project database systems. Also shown is a pull down menu function to select a particular project, thus providing a mechanism to select and load the data for an authorized project into the application's toolset for analysis and presentation output. In sum the Explorer Project Manager 100 provides the pathway to all of the program's functional utilities

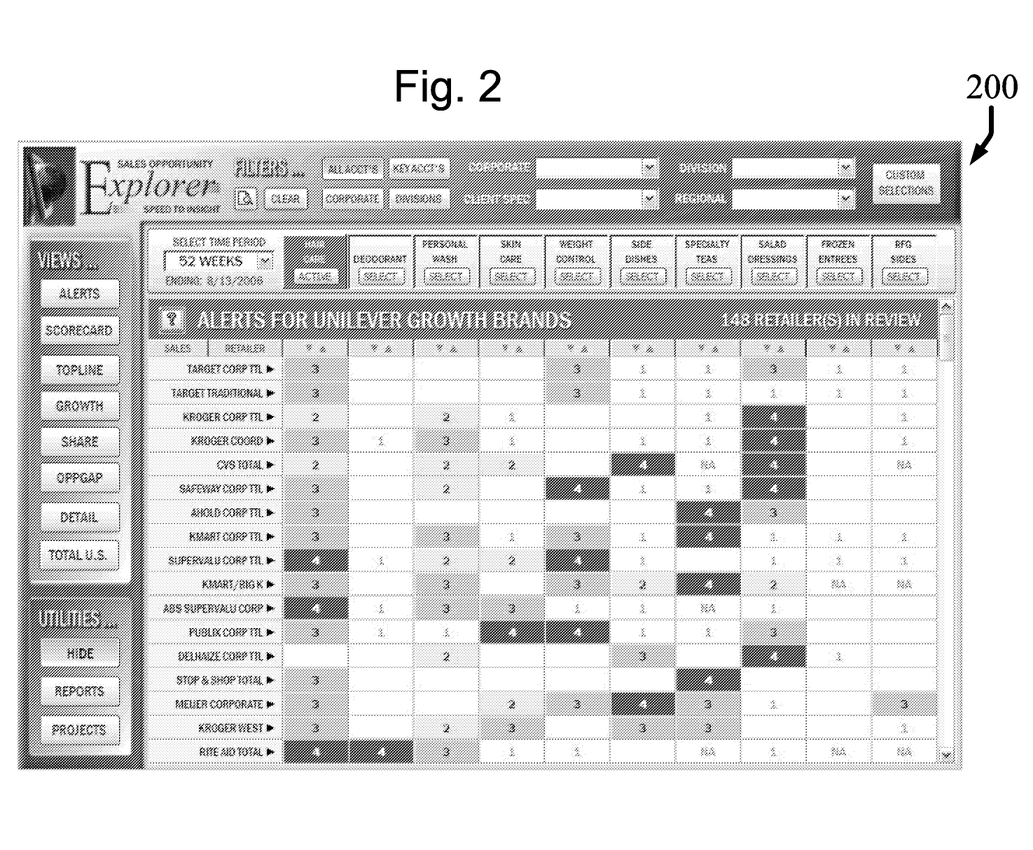

Referring now to FIG. 2, an exemplary screen shot for the SOE Tool is generally depicted at 200, titled “Performance Alerts View”. The Performance Alerts View 200 provides the first step in a discovery process. This process utilizes a heat map layout that displays a directional performance and opportunity representation of the number of business conditions that fall below identified benchmarks of sales performance. The presence of these conditions triggers an alert that is tallied for each of the business units or brands represented, across a list of key retailer customers. The customers are ranked by total dollar sales of all products in the descending order of their contribution to the total business of the manufacturer for the selected time period.

Functionality for the Performance Alerts View 200 is four key business metrics:
1. Dollar sales volume growth trend versus the prior year
2. Dollar sales volume growth trend versus overall category growth trend
3. Retailer opportunity gap (share of category or brand sales versus share of market ACV (All Commodity Volume)
4. Dollar share growth trend

These metrics can be stated otherwise, for instance:
1. Our brand sales are declining versus the prior year
2. Our brand sales growth is not keeping pace with category growth
3. Our brand share has declined.
4. Our brand has an opportunity gap, the retailer is not getting their fair share of market sales.

Thus, the alert conditions that are evaluated are:
1. Brand sales trends that are declining versus the previous year;
2. Brand sales trends that are underperforming the category/segment
3. Brands that have a dollar sales opportunity gap at a particular retailer
4. Brand shares of the category/segment that are down versus the previous year

The above four (4) business metrics are expressed as “alerts” that indicate a level of opportunity or focus that should be given to a particular business at a particular retailer. The business metrics that are lagging an identified benchmark represent a condition that triggers an alert, communicating urgency to a business manager. Alerts are summed and conditionally formatted to provide easy visual representation of urgency or opportunity. Applied filtering and sorting (discussed below) on this view of alert identification enables significant speed to insight otherwise not available in conventional data tools.

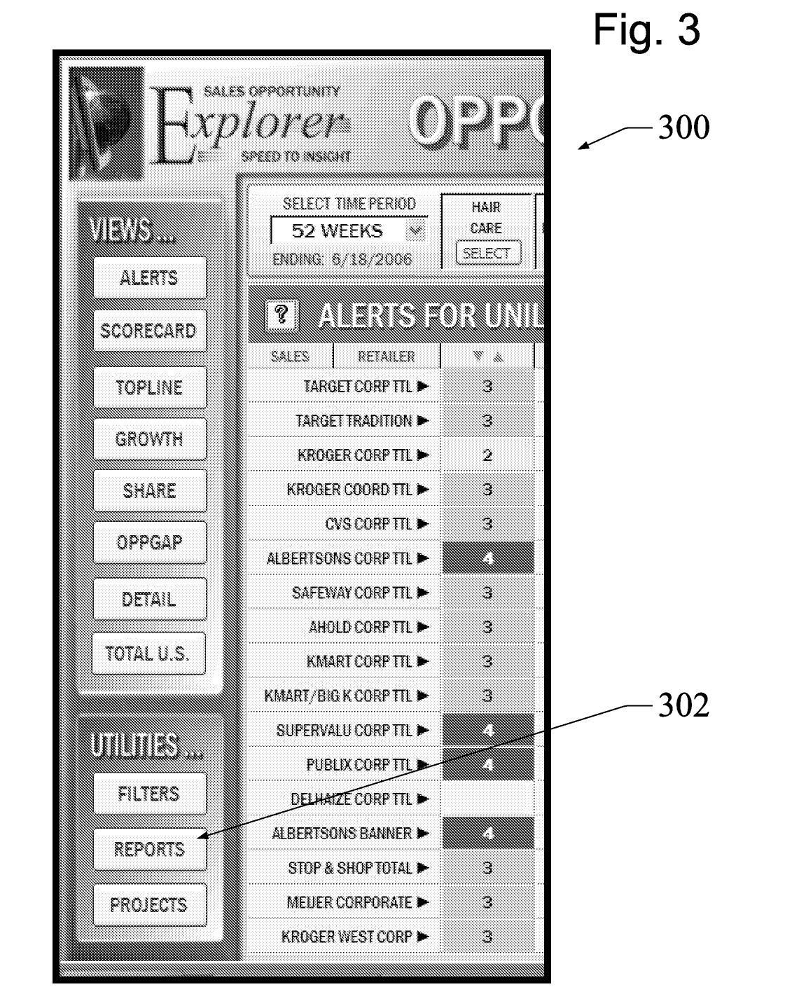

The number in each cell of the Performance Alerts View 200 indicates the number of these alerts that are active for the indicated category at the indicated retailer. Also capable from the Performance Alerts View 200 is that reporting can be performed on each Alert, where the alert scorecard quantifies the impact of each alert via visual cues. As seen in screen shot 300 of FIG. 3, which shows an expanded portion of the Performance Alerts View 200, the SOE Tool has the ability to filter accounts (discussed below), provide a view and a summary of the report by selected retailers, and allow the user to retrieve reports 302 and to format and transmit reports (e.g.; via e-mail).

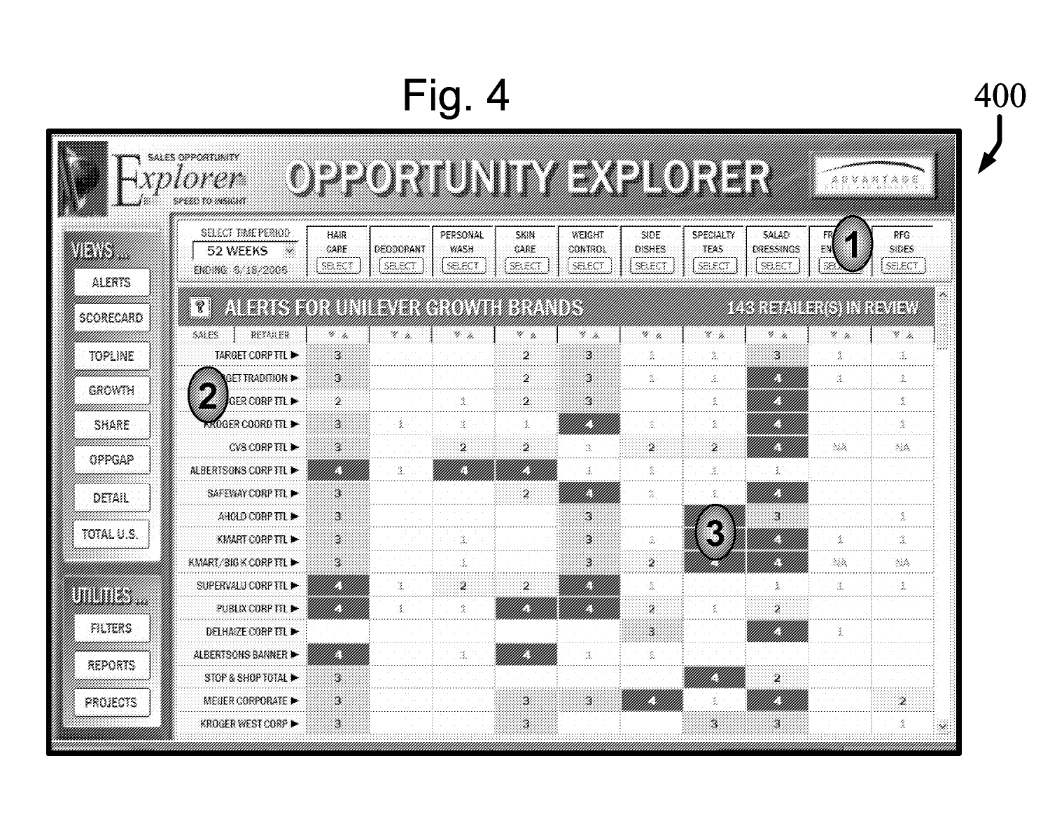

As shown in FIG. 4 at reference numeral 400, the Performance Alerts View 200 is marked with three (3) indicators to respectively show key components of this dashboard as detailed below:
1. Client categories are listed across the top (up to 10 categories can be included)
2. Retailers are listed on the left side of the grid
3. The numbers of ALERTS that exist for each category at each retailer are identified in the grid of cells as detailed below:
   Blank Cell=No alerts exist
   Color #1 Cell (1)=One alert exists
   Color #2 Cell (2)=Two alerts exist
   Color #3 Cell (3)=Three alerts exist
   Color #4 Cell (4)=Four alerts exist
   NA=Products are not in distribution at the identified retailer(s)

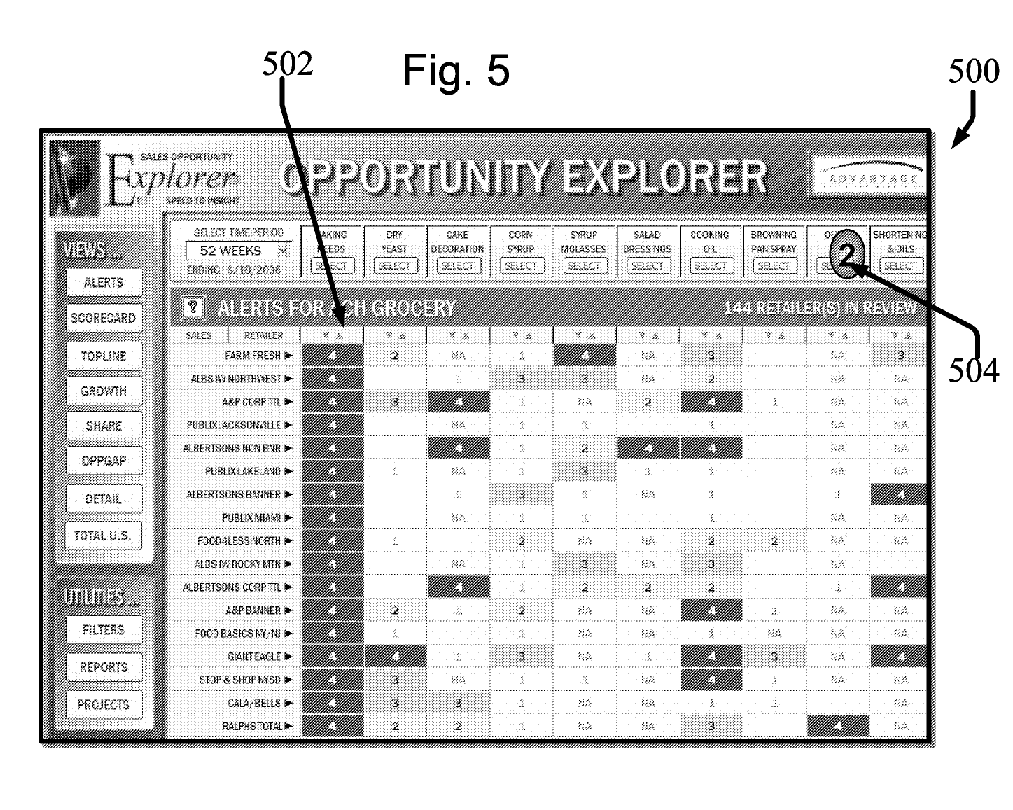

The grid aggregates the totals for the alerts for all the retailers that have a given level of alert. For instance, as show in FIG. 5 at reference numeral 500, all retailers that have level 4 alerts can be aggregated to show the total sales issues and opportunity issues with a percentage at each alert level for the total retailer mix. The alerts can sorted (see “2” and reference numeral 504 in FIG. 5) to best illustrate the impact upon a retailer in each category. A user can use toggle buttons 502 to sort the alerts, and can use a sort function for any category along the category row to reset the Alerts

The Performance Alerts View 200 shows a View Menu listed on the left side of the tool. VIEWS enable the user to drill down into a specific category. “Speed to Insight” views are available for the following detail areas:
1 SCORECARD: Provides a Summary of information for the Alerts
2. TOPLINE: Provides a detailed view of the key metrics for each retailer and identifies the specific alert conditions.
3. GROWTH: Graphically represents the bottom and top 10 growth retailers.
4. SHARE: Graphically represents the bottom and top 10 share growth and share retailers.
5. OPP GAP: Graphically represents the top 10 retailers with the largest opportunity gaps.
6. DETAIL: Provides a detailed view of all the brands performance within a category.
7. Total US: Provides a comparative of a brand's performance, in the category selected, across Food, Drug and Mass as data is available.

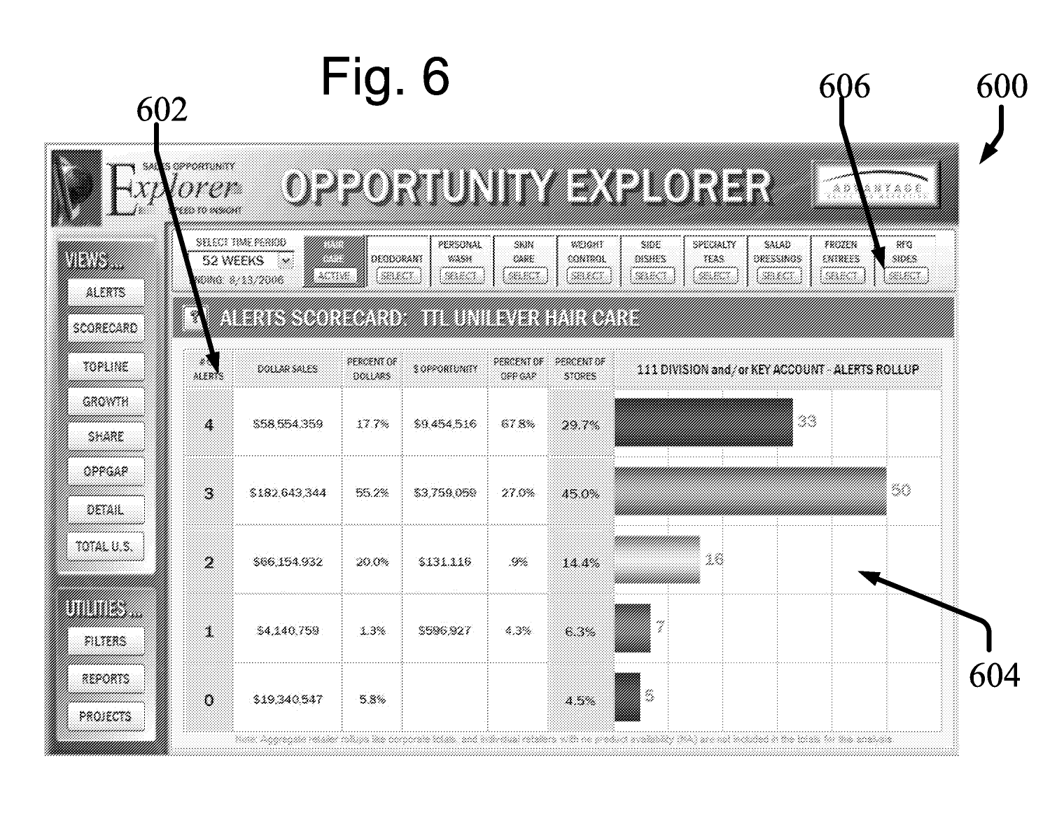

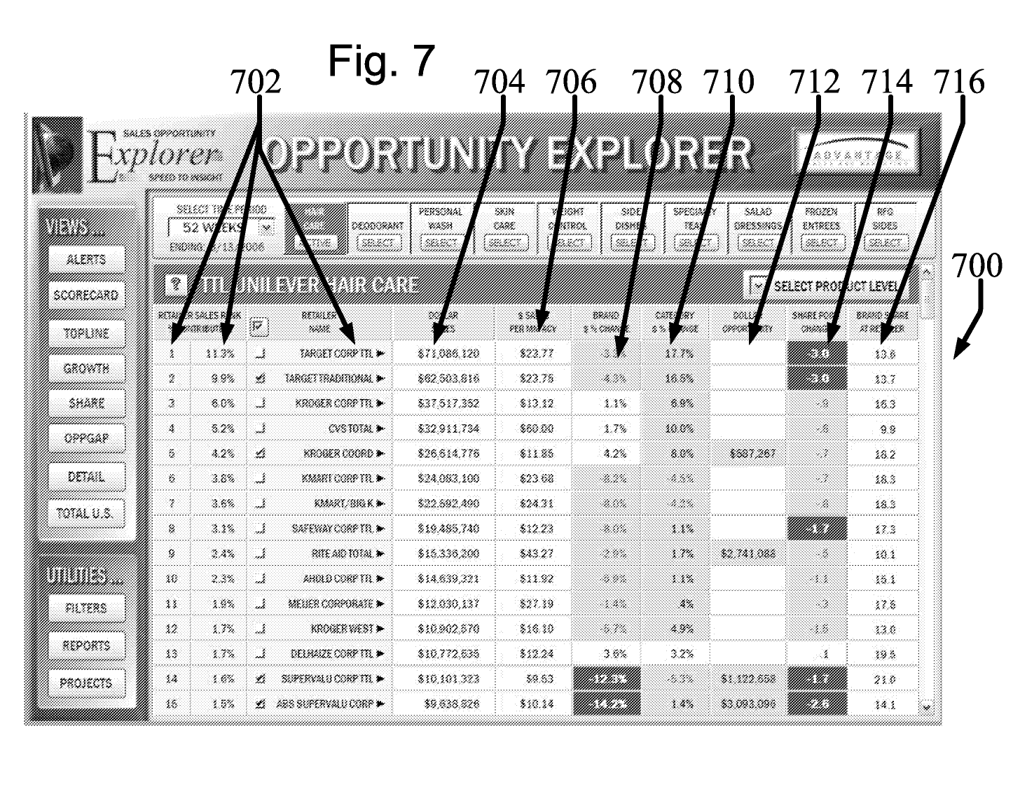

Referring now to FIG. 6, an exemplary screen shot for the SOE Tool is generally depicted at 600, titled “Score Card View”. The Score Card View 600 builds on the alerts view described above by consolidating and ranking the selected group of retailers into the levels of focus/opportunity described above. The Score Card View 600 allows the user to view and identify business performance, in consolidated retailer clusters, based upon the number of identified alert conditions. This view 600 communicates the overall “health” of a business based on the number of focus or opportunity conditions that are present. The Score Card View 600 identifies the number of instances that an alert of concern is present, and indicates the size of the business that is at risk based on the presence of this condition.

The Score Card View 600 provides the user with the opportunity to assess the impact of each alert, by category, across all retailers:
No. 1 as seen in FIG. 6 at reference numeral 602: Comparison of Key Alert metrics from the prior reporting period:
   Total Brand Dollars represented by the Alert
   % of Total Brand Dollars represented by this Alert
   Total Opportunity Gap Dollars
   % of the Total Brand Sales Opportunity Gap represented by this Alert
   % of Total Stores represented by each Alert
No. 2 as seen in FIG. 6 at reference numeral 604: Bar Graph shows the Number of Total Retailers in each alert level for the current and last reporting period.
No. 3 as seen in FIG. 6 at reference numeral 606: The user can move between categories by using the Select/Active button below each category.

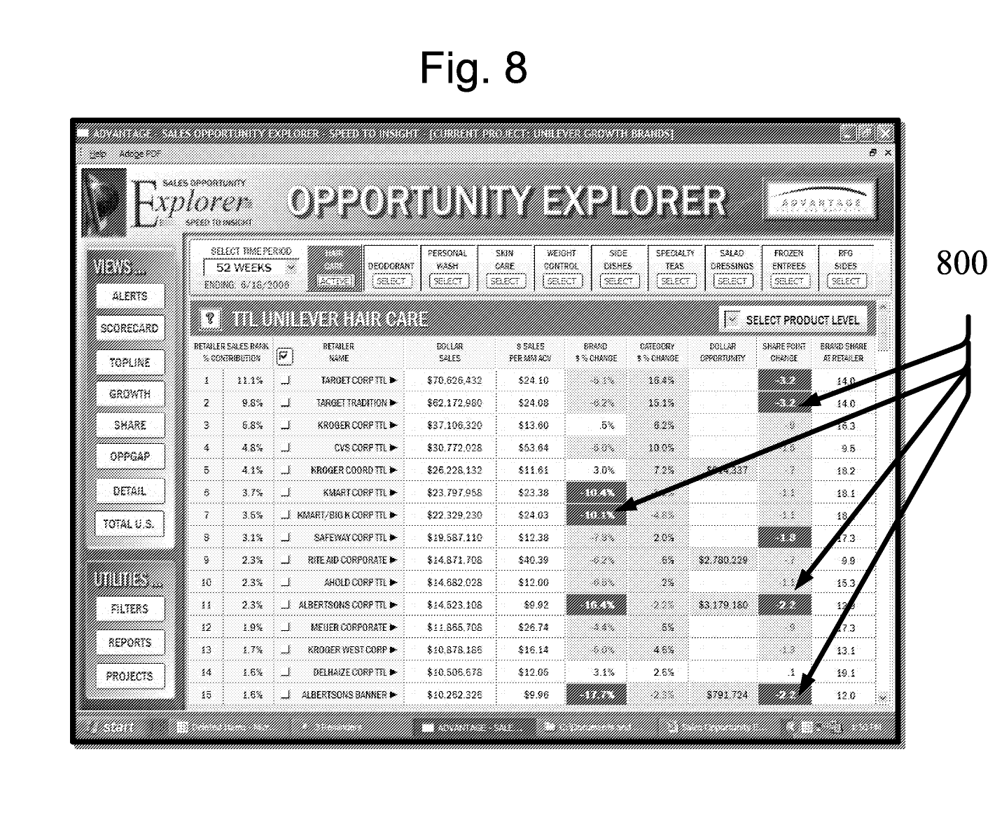

Referring now to FIG. 7, an exemplary screen shot shows at reference numeral 700 for the SOE Tool titled “Sales Topline View”. The Sales Topline View 700 introduces a select number of data metrics in support of the sales opportunity discovery process. Introduced at this point in the process, they are given a unique dimension based on the opportunity identification insights that are presented in the previous two views of the tool.

This view is customized to the most relevant business product grouping and provides the ability to express the performance results at a total product portfolio, or customized segmentation, brand or sub-brand level.

The Sales Topline View 700 displays a series of performance measures for each of the retailers for the selected time period, as shown at reference numeral:
702: Rank Order and % Contribution of Retailer to illustrate the retailer's overall importance to the business.
704: Total Product Dollar Sales to show absolute dollar volume at the retailer.
706: Dollar Sales per MM$ of ACV (All Commodity Volume) to communize volume across retailers illustrating the quality of business at a retailer.
708: Brand $ Sales Change vs. Previous Year to indicate a business' growth at a
710: Category/Segment $ Sales Change to indicate the growth rate of the category
712: Dollar Sales Opportunity at the Retailer to indicate if an opportunity gap
714: Product Share Point Change vs. Previous Year to illustrate a brand's share
716: Product Share of Category/Segment at Retailer to identify a brand share at the retailer.

There is a dropdown list control providing the ability to select any of the product levels included in the data set for display in the view. The performance/opportunity standards for each of the alert levels are highlighted. There is also an enhanced highlight for Sales and Share Change to identify those retailers evidencing a higher than average opportunity. By default the retailers are listed in descending order of their contribution to the total business of the manufacturer. This is determined by their total dollar sales of all client products for the selected time period.

The field column heading is also a sort control that responds to a click or double-clicks of the mouse to sort that particular column in ascending or descending order. A single click sorts Best to Worst and a double-click Worst to Best. Beside each retailer name is a check box that allows for the tagging of retailer's for particular consideration. The tagged retailers will display in the Detailed Summary View with more depth of analysis.

Cell shading can be used to indicate a metric for the retailer that is associated with an alert. For instance, as seen in FIG. 8, a color such as bold red (seen at reference numeral 800 by darker shading), can indicate among all the retailers selected who have a decline, an average of their performance has been created, and the performance for that retailer is worse than that average.

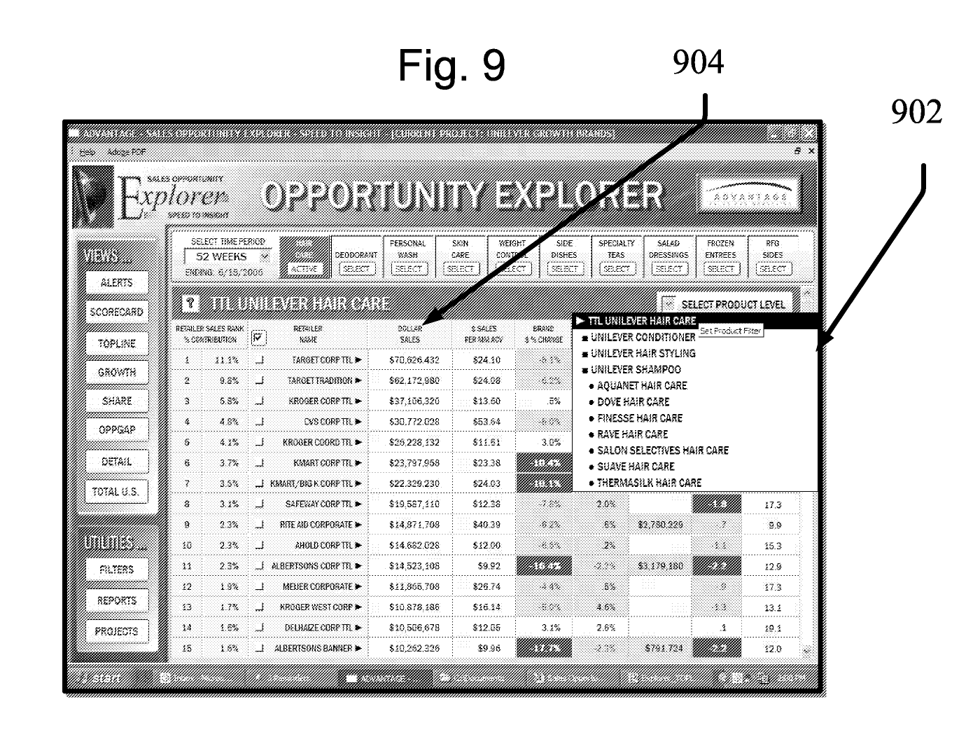

FIG. 9 shows a recap of the navigation capabilities of the Topline View, where a user can select a desired time period that enables the selection of a 52, 24 or 12 week time period. The user can also make a category selection by clicking on the “SELECT” button from each column to activate that category. The user can navigate from category to category while in the Topline view.

As shown at reference numeral 902, the user can select a brand to view (at the product level) by clicking on the drop down arrow to drill down into category segments and targeted brand groups. The selected Brand View will be identified in the report header (See the “?” icon on the screen shot). At reference numeral 904, there is a column sorting function illustrated, which function facilitates analysis such that each column can be sorted in ascending or descending order: by either a single click on any column header to sort in descending order and a double click on any column header to sort in ascending order

FIGS. 7-9 show that visual highlights can be used as alerts in the alert section. With the highlighting, there is an emphasis where alerts occur at each recorded level. If a customer is in a sales decline that is greater than the average of all the retailers that had declined, the highlighting will even further emphasize that with another shading, thereby giving the viewer a visual cue as to the severity of the problems. This sort of presentment to the viewer can be particularly tested against a certain standard, norm or tolerance, such as what is acceptable, and what is not acceptable. Based upon deviation from a normal or standard, a table-look up can be used to determine the appropriate visual cue—such as the particular color or shading thereof to render on the user interface as the appropriate alert, warning or indicator. Stated otherwise, more severe warnings will greatly intensify for the viewer to see as a type of gauge. Stated otherwise, when a calculation is made, a test will then be made of that calculation against a norm. A look up is made for the deviation from a recognized norm (e.g.; a table look up) in order to express that deviation, and then the expression is rendered with an appropriate visual cue on the user interface accordingly.

An automatic running average is taken that readjusts itself based on the selection of retailers that have been filtered or selected. The system takes the ones that are declining, averages them, and if the loss of a particular retailer is higher than the average, the viewer will see that emphasized with even greater visual cues on the user interface. The system averages the loss of the retailers that are down, and if the decline is greater than the average of those, this will result is a specialized display to depict the alert. The benchmark is the list average.

Basically, the user is reviewing the data to try to determine the retailers with the biggest opportunity on a particular category. The user can then make their memos for a retailer that they have tagged on the screen to associate their conclusions with that particular data that is being represented as an interactive feature.

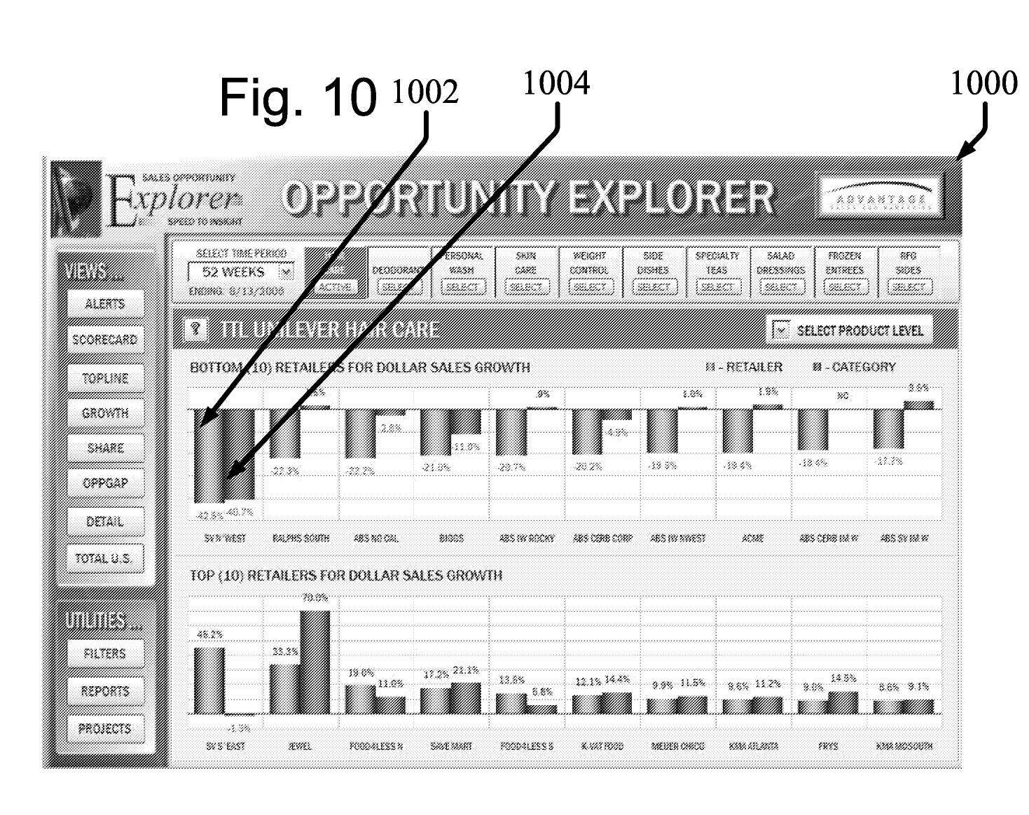

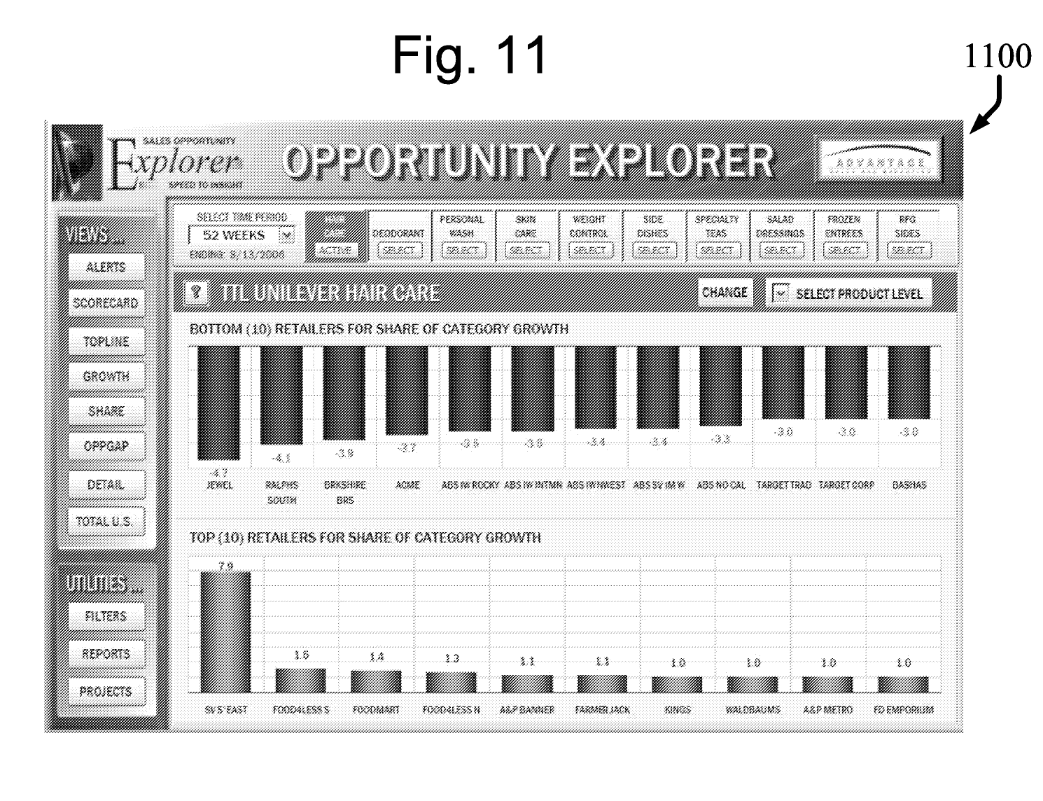

Referring now to FIG. 10, an exemplary screen shot is shown at reference numeral 1000 for the SOE Tool titled “Sales Growth View”. The Sales Growth View 1000 is part of the sales issues and opportunities discovery process of the SOE Tool. This component graphically represents the bottom and top 10 retailers for dollar volume growth percent change versus the previous year for the selected time period. These two charts provide great “speed to insight” to visually identify top and bottom performers based on sales volume growth or decline.

Using filter capabilities allows the end user to create a custom grouping of specific retailers for performance benchmarking. There is a dropdown list control providing the ability to select any of the time periods available in the data. There is also a dropdown list control providing the ability to select any of the product levels included in the data set for display in the view. With a simple click on the SELECT button the user can switch categories while still maintaining all of the time and retailer settings.

The Sales Growth View 1000 has an upper bar chart that: graphically identifies the bottom 10 retailers for dollar sales growth. A blue colored bar 1002 blue bar represents the brand's growth and the red bar 1004 represents the category growth, thus enabling performance benchmarking. The lower bar chart in the Sales Growth View 1200 graphically identifies the top 10 retailers for dollar sales growth.

Also seen in the Sales Growth View 1000 are navigation tools, including the ability to:
1. select Time Period: enables selection of a 52, 24 or 12 week time period
2. select a category: click on the SELECT button from each column to activate that category. You can navigate from category to category while in the Growth view.
3. select a segment and brand: utilize the navigation arrows to drill down into category segments and targeted brand groups. The selected View will be identified in the report header (Next to the Question Mark—“?”).

If a user is in a particular project where the data is organized into categories, the user will go through a process of filtering to look only at the retailers in a particular division. After seeing one category, the user can use the same filters (customers and retailers) for different categories, thus removing the need to reset filters upon switching categories.

The Sales Growth View 1000 has illustrated components that graphically present the top and bottom ten retailers for dollar share growth. For instance, there may be 140 retailers that are presented in the data and they're all presented in the top line in full detail. As such, the best and worst retailers are readily seen. With the filtering capability, the user can restrict the list to a particular market area so that there will be presented the top ten and the bottom ten of what has been filtered. As such, the biggest opportunities are readily seen and the best performers are also. The filter capabilities allow the viewer to restrict the list of the customers that are to be seen, even if all customers are to be seen in varying degrees based on using the different filtering settings.

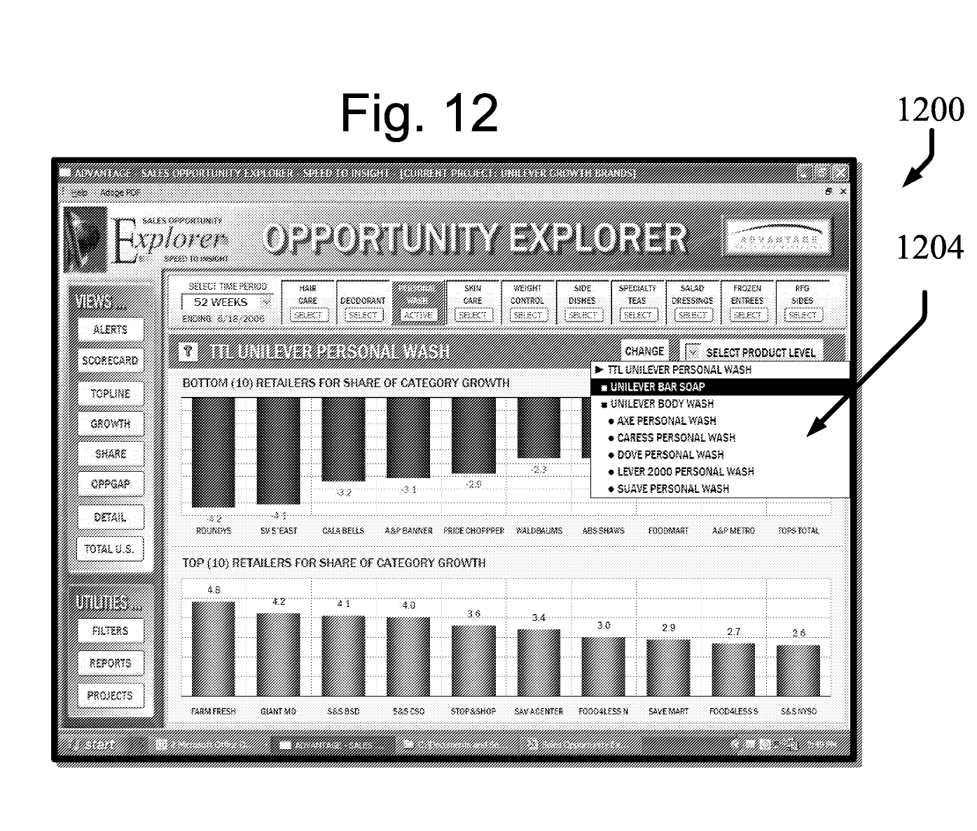

Referring now to FIG. 11, an exemplary screen shot is shown at reference numeral 1100 for the SOE Tool titled “Sales Share/Change View”. The Sales Share/Change View 1100 is a step in the discovery of sales issues/problems and sales opportunities. This component graphically represents the bottom and top 10 retailers for dollar share growth versus the previous year for the selected time period. The component can also change to display the actual share levels with the click of a button. These two charts provide great “speed to insight” to visually identify top and bottom performers based on sales share change growth or decline.

The user can use the custom filter capabilities to create a custom grouping of specific retailers for performance benchmarking. There is a dropdown list control providing the ability to select any of the time periods available in the data. As shown in FIG. 12, there is also a dropdown list control providing the ability to select any of the product levels included in the data set for display in the view. With a simple click on the “SELECT” button the user can switch categories while still maintaining all of the time and retailer settings.

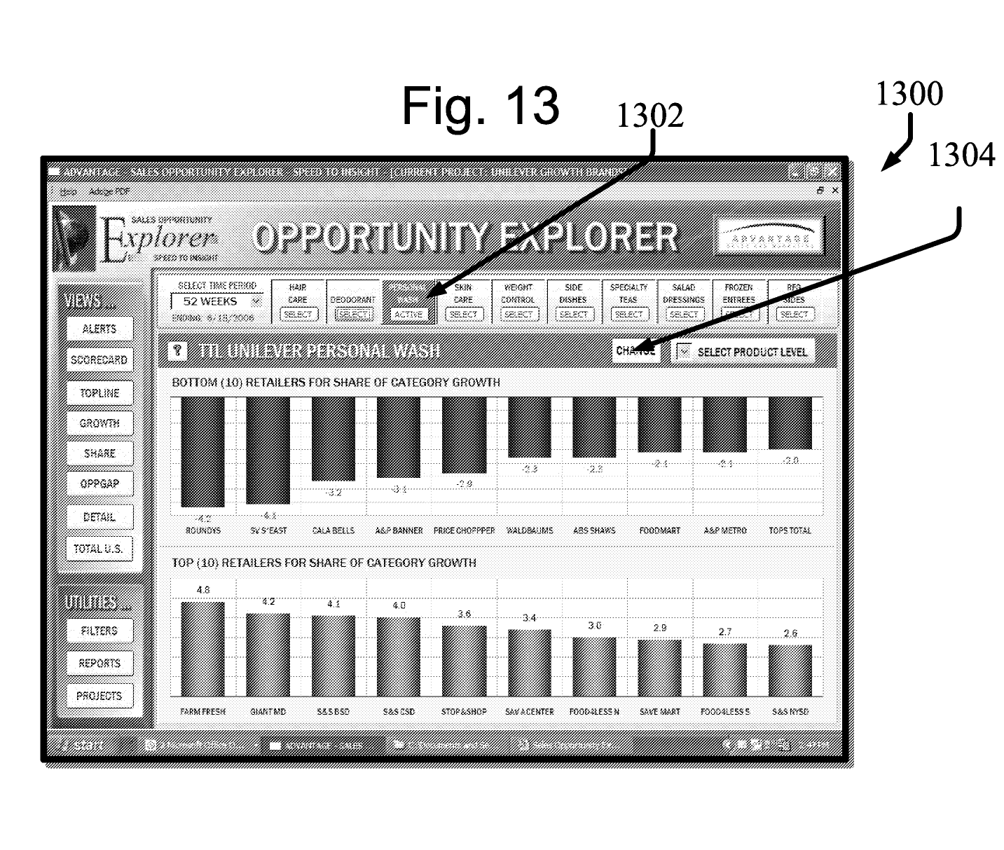

Referring now to FIG. 13, an exemplary screen shot is shown at reference numeral 1300 graphically shows the bottom and top 10 retailers for dollar share and share change. An upper bar chart graphically identifies the bottom 10 retailer for share and share change. A lower bar chart graphically identifies the top 10 retailers for share and share change.

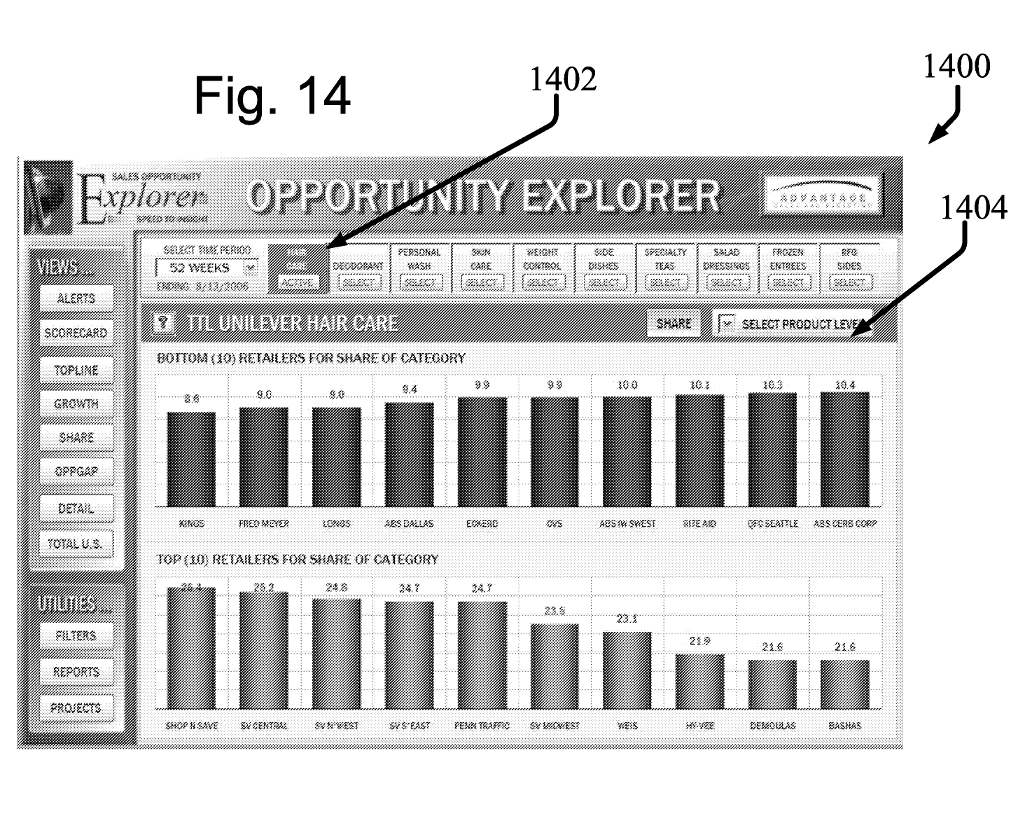

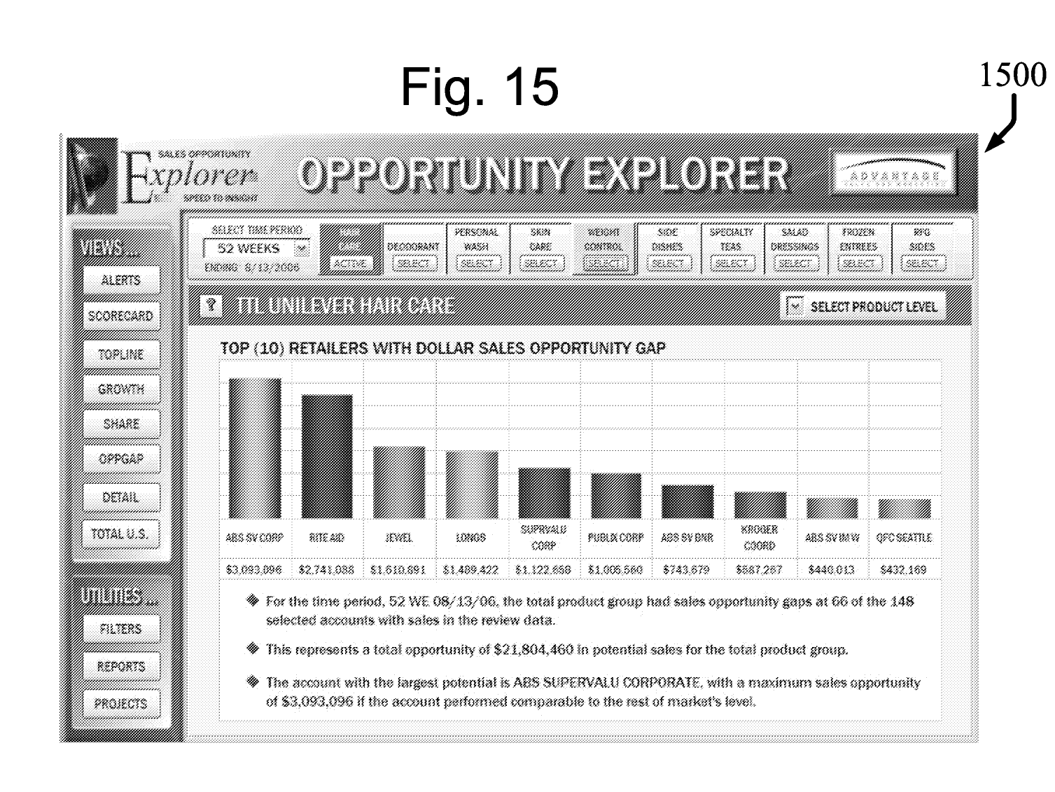

Navigation tools provide in screen shot 1300 include:
1. The ability to select a time period of a 52, 24 or 12 week time period
2. A category selector function 1302 in FIG. 13 and function 1402 in FIG. 14 by clicking on the “SELECT” button from each column to activate that category. The user can navigate from category to category while in the Sales Share/Change View 1300.
3. Segment and Brand Selector: the user can utilize the navigation arrows to drill down into category segments and targeted brand groups. The selected View will be identified in the report header (Next to the ? icon; see also reference numeral 1204 in FIG. 12, and reference numeral 1404 in FIG. 14).
4. Share Change or Dollar Share Selector: the user can activate this function by clicking on the button to shift from Share Change to Dollar Share (See reference numeral 1304).

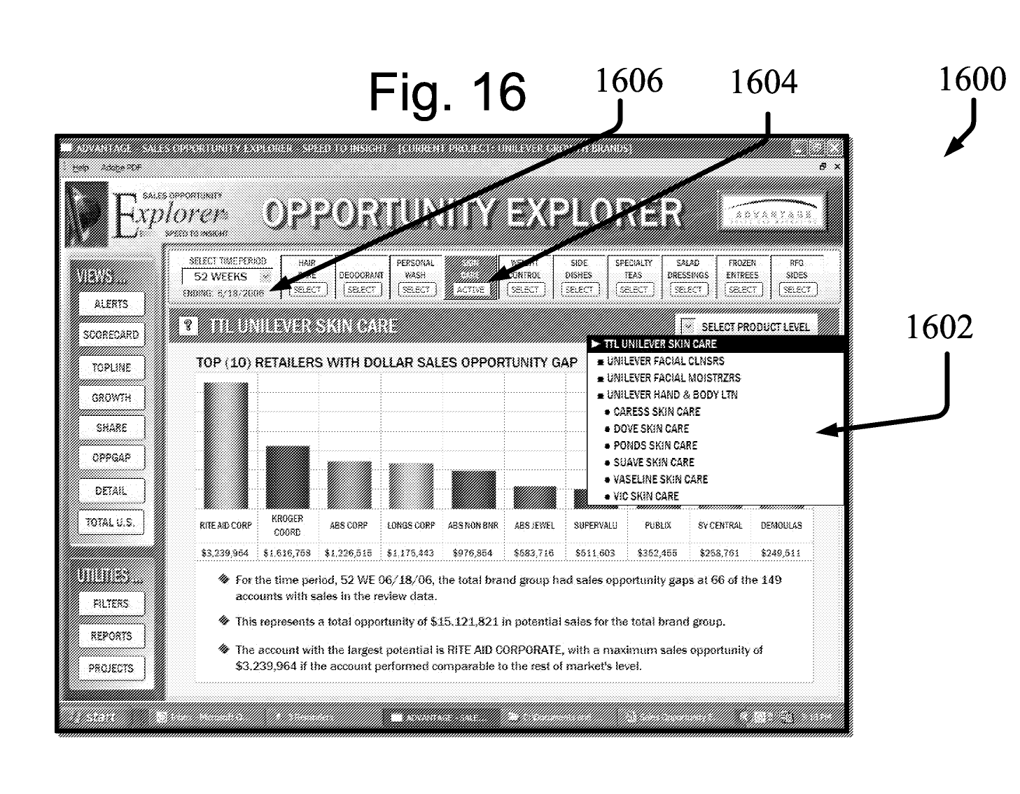

Referring now to FIG. 15, an exemplary screen shot is shown at reference numeral 1500 for the SOE Tool titled “Sales Opportunity Gap View”. The Sales Opportunity Gap View 1500 helps users in discovering sales opportunities. This component graphically represents the top 10 retailers for dollar sales opportunity for the selected time period. The Sales Opportunity Gap View 1500 graphically presents the degree of opportunity gap across the retailers with the most sales potential. It displays the actual calculated dollar sales gap for each retailer. The Sales Opportunity Gap View 1500 presents automated bullet text to emphasize key elements in the opportunity gap analysis such as:
1. Total number of retailer accounts with opportunity gaps.
2. Total value of all opportunity gaps combined.
3. Identifies the retailer account with the largest opportunity gap.

The user can make use of custom filter capabilities that allow for the creation of a custom grouping of specific retailers for performance benchmarking. There is also a dropdown list control providing the ability to select any of the time periods available in the data. There is also a dropdown list control providing the ability to select any of the product levels included in the data set for display in the view. With a simple click on the “SELECT” button the user can switch categories while still maintaining all of the time and retailer settings.

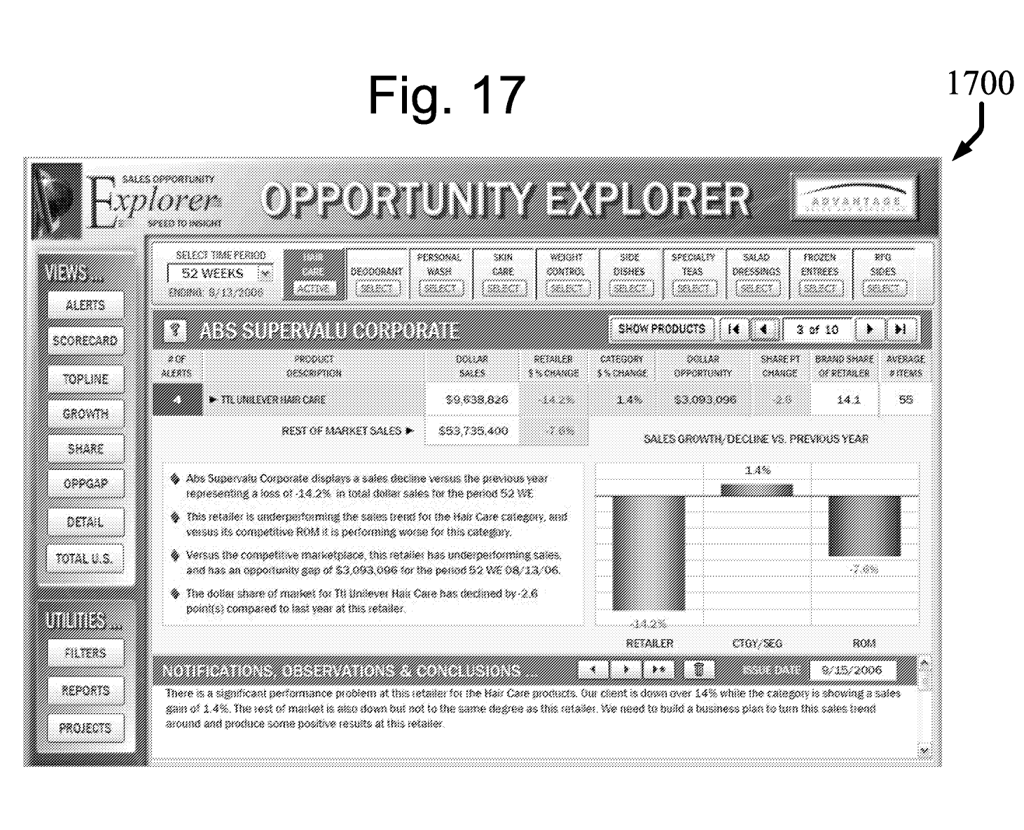

FIG. 16 shows a screen shot 1600 at which there is illustrated a sales opportunity gap by way of graphic representation of the top 10 retailers with the largest opportunity gaps. A bar chart is used in FIG. 16 to graphically identify the top 10 opportunity gap retailers. Text has been generated to provides insight and analysis so as to be able to identify the following:
1. Total number of accounts with opportunity gaps.
2. Total value of all opportunity gaps combined.
3. The account with the largest opportunity gap.

Navigation tools are seen in FIG. 16, where reference numeral 1606 shows the tool to select a time period (e.g.; the user can select a 52, 24 or 12 week time period), and reference numeral 1604 shows the tool to select a category by clicking on the “SELECT” button from each column to activate that category. The user can navigate from category to category while in the user interface depicted by screen shot 1600. Reference numeral 1602 depicts a segment and brand selector tool whereby the user can utilize navigation arrows to drill down into category segments and targeted brand groups. The selected View will be identified in the report header (Next to the question mark icon by the bar labeled “Total UNILEVER SKIN CARE”).

FIGS. 15-16 graphically present the degree of opportunity gap across the retailers with the most sales potential. The degree of opportunity gap is a dollar number that is based on the dollar sale. Through a calculation that is used to create ‘opportunity gap’, a representation is made of the dollar opportunity that a user may have at a particular retailer if that retailer performed up to its expectation (achieving its fair share of market sales versus competitive retailers), then that would be the dollar opportunities that could be gained.

In particular, there is a fair share of sales that a retailer should have overall. A departure from this reflects a dollar value for the gap between what is selling at a retailer and what should be expected to be sold. The statement of ‘accounts with opportunity gaps’ express in bullet points some additional metrics. In other words, what it is representing is the top 10 of whatever geography filter has been selected. There is a representation of the top 10 accounts individually, but then in the bullet points, the screen shot 1500 shows that the total for all of the accounts in a selected region would equal an amount of opportunity gap, which is reemphasized in the automatically created text seen at the bottom of screen shots 1500-1600, respectively in FIGS. 15-16. As such the charts depicted in FIGS. 15-16 at the top of screen shots 1500-1600 have corresponding text that is automatically generated and rendered at the bottom of the screens.

Referring now to FIG. 17, an exemplary screen shot is shown at reference numeral 1700 for the SOE Tool titled “Performance Detail Summary View”. The Performance Detail Summary View 1700 is the culmination of the process to discover sales issues/problems and sales opportunities. View 1700 enables the end user to construct a detailed analysis of a selected category for a specific retailer(s). This is an interactive component enabling the user to enter commentary supporting the business insights. This component is designed as a deliverable to facilitate the communication of the sales performance and proactive recommended action plan.

Retailers for each category are selected in the Topline view and tagged for inclusion in the detail summary. The component expresses a summary for the total product portfolio of all of the alerts and measures presented in the other views for the selected retailers. For greater detailed analysis the component includes incremental measures for performance benchmarking.
1. Competitive “Rest of Market” comparisons
2. Average Item Counts

The Performance Detail Summary View 1700 displays a comparative graph of the key growth measures for visual comparison. Automated bullet text is generated from the calculated numbers to emphasize key performance elements represented by the data. These bullet points are composed of concatenated text strings and data points conditionally reflecting positive and negative performance. The automated bullet text that is generated does not require any user interaction or input in its creation. View 1700 additionally has the ability to toggle to a supplemental display of all of the product level detail that makes up the total product portfolio.

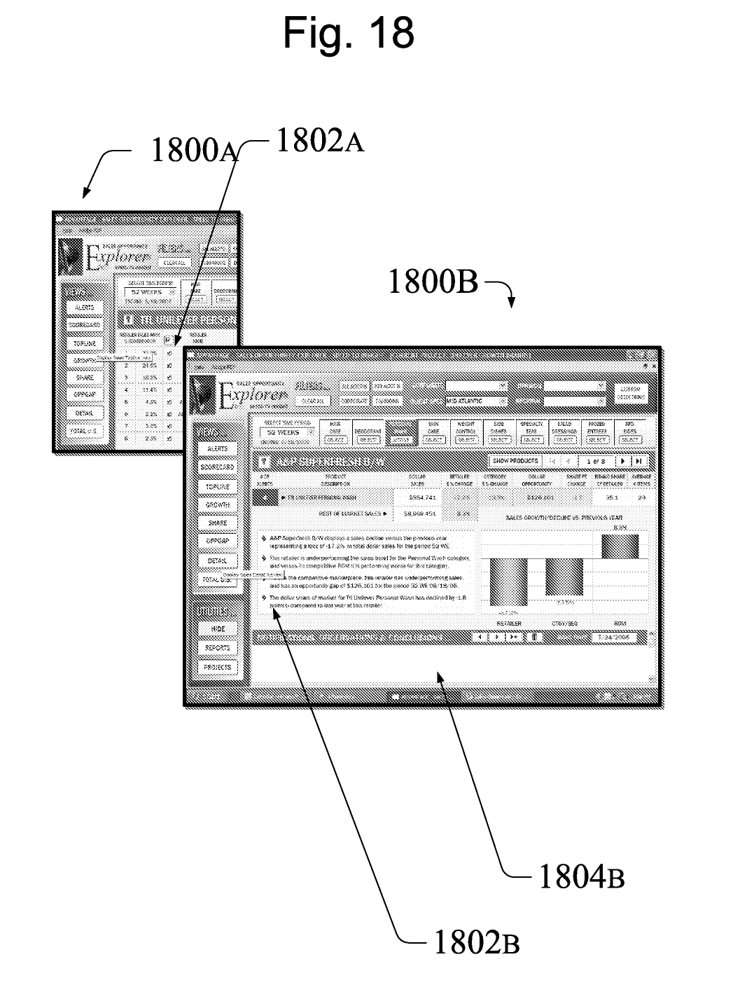

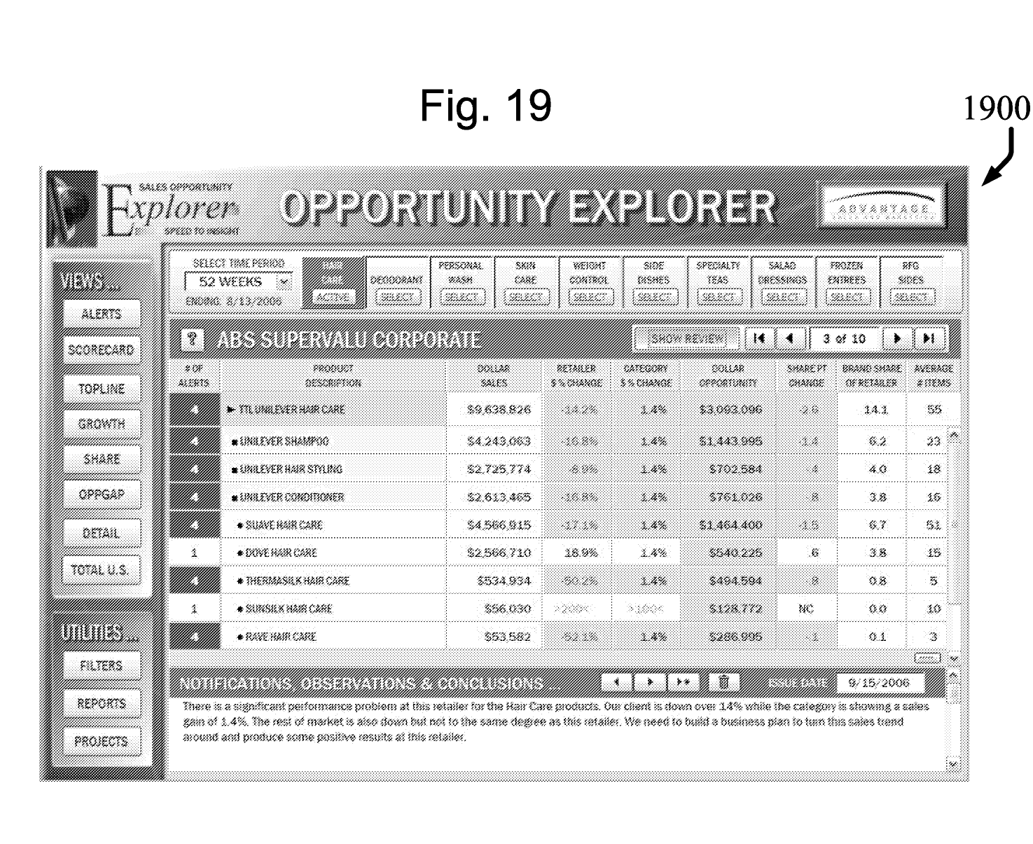

Referring now to FIG. 18, there are shown respective portions of the Performance Detail Summary View 1800 which provide a concurrent view of all of a user's brands within a selected category. Key metrics included in this view are:
1. User pre-selected Retailers in the Top Line view that display here (see reference numeral 1802A),
2. Product Description: Details each segment and brand group within the category.
3. Dollar Sales: absolute dollar volume at the retailer.
4. Account $ % Change: indicates the user's business growth at a retailer.
5. Category $ % Change: indicates the growth rate of the category at the retailer.
6. ROM $ % Change: indicates the growth rate of the user's segment/brand in the Rest of Market.
7. $ Share Category: identifies the user's segment/brand share within the category.
8. Share PT Change: indicates the point change for the segment/brand share within the category.
9. Average # Items: identifies the average number of items for the segment/brand that scanned during the selected time period.
10. Bullet points are provided to indicate insights (See reference numeral 1802B)
11. Graphical representation of the Brand % Sales Chg for Retailer, Category and ROM
12. Notification, which is intended for user to input comments and email. These notes will remain part of the files history. (See reference numeral 1804B)

Referring now to FIG. 19, there is shown a screen shot 1900 which provides a user with a vehicle to further determine the key product or products that are causing the sales differential that makes up the sales opportunity. In the bottom portion of FIG. 19 in screen shot 1900, the user can enter commentary supporting the business insights displayed in the analytics presented above in screen shot 1900 to provide directional insights for field sales support and client partners.

In each of the views of the SOE Tool, there is an interactive component basically supporting an interface where the user can input to make commentary on what they are looking at. The user can do so after they have gone to through the process of discovering sales issues/problems and sales opportunities by way of seeing alerts through different graphic elements and alert numbers. Data is represented to a user in the top line view (See FIG. 7). There are some additional measures that are added in, like the average number of items. A graphic representation can be presented of the sales versus last year for a retailer against its category and also against its rest of market so the user can make a comparison.

The SOE Tool automatically generates text from calculated results to further emphasize various alerts to user relative to key measurements. The text can be presented as bullet points which allow a user to toggle to all of the levels of granularity. As the user reviews the graphical renderings, the user can make notifications, observations and conclusions that are input as information right into the SOE Tool database for historical use.

The viewer can interface with others by sending a document (e.g.; PDF format) or by automatic emails, where the tool starts an email client and need not print. Each memo or note that the user puts in to the database of the SOE Tool can be retained.

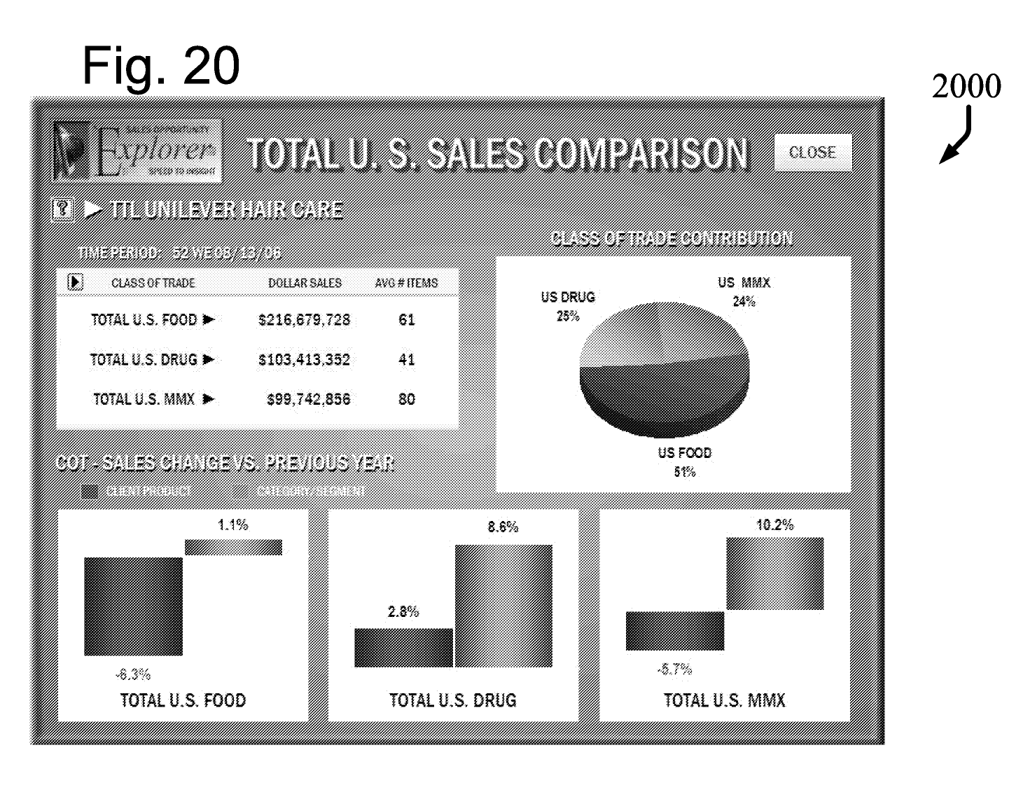

Referring now to FIG. 20, an exemplary screen shot is shown at reference numeral 2000 for the SOE Tool titled “Total US Review”. The Total US Review 2000 is a supplemental component that enables the user to benchmark sales performance against the total sales for the total U.S. This provides the user a vehicle to determine if performance conditions for the products that are reflective at the retailer levels are systemic to the national marketplace aggregate. Screen shot 2000 shows that the tool can express the sales and sales change percentage for each class of trade for total U.S. The Total US Review 2000 graphically displays the share of each class of trade for the selected product. It also graphically presents the sales growth of the selected product and the total category for each class of trade.

The Total US Review 2000 can be a kind of an addendum popup tool. With this view, when major retailers are having negative conditions for a particular product, the popup tool will show a review of the total US business on that particular product. This will help the user to determine whether or not this problem with individual retailers is systemic across the entire United States by class of trade, thus being a global benchmark over the US. The user can thereby be surer of conclusions and recommend strategies to solve a sales related problem.

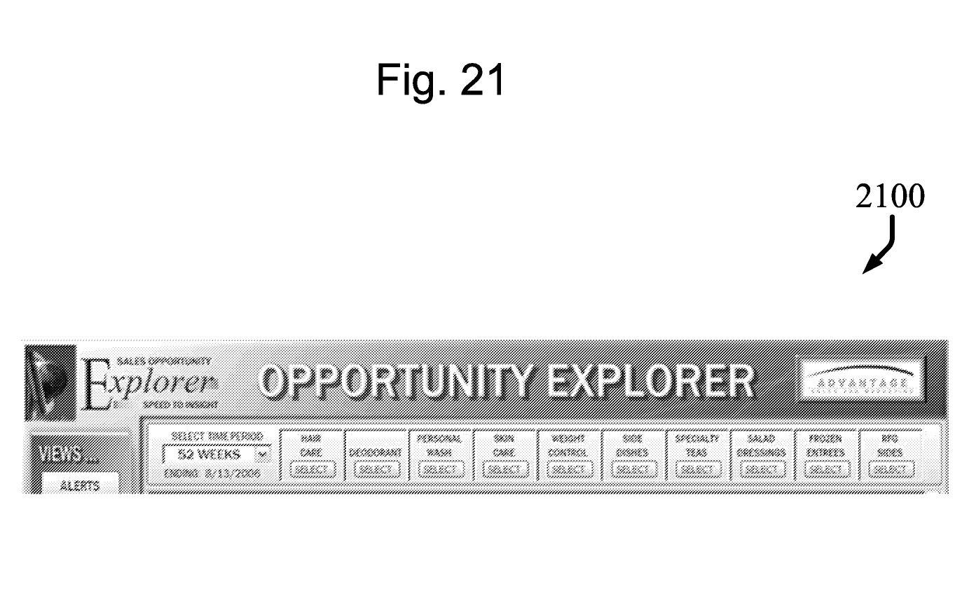

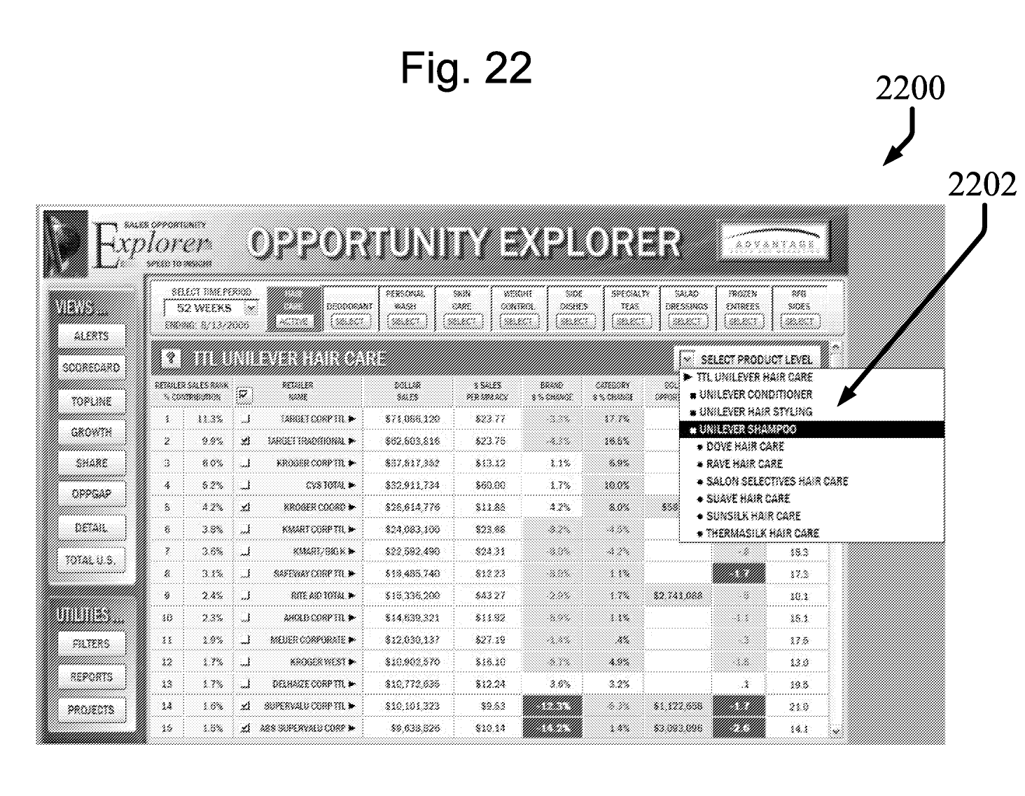

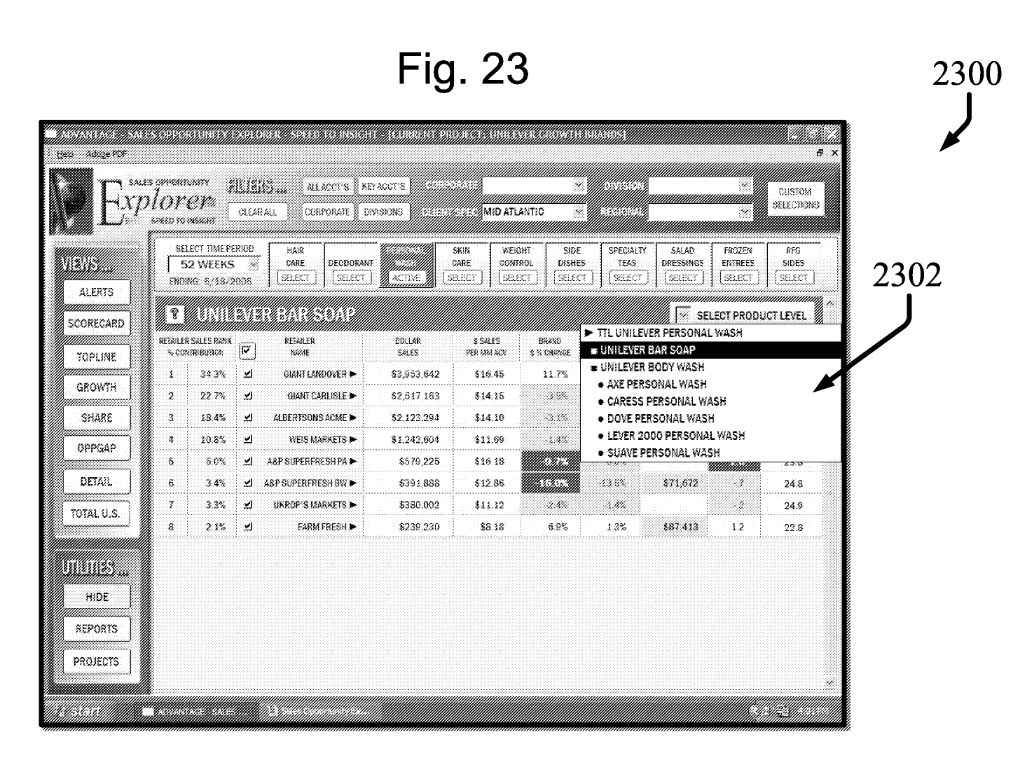

Referring now to FIGS. 21-24, respective exemplary screen shots are shown at reference numerals 2100-2400 for the SOE Tool. These screen shots illustrate the user's ability to better operate the SOE Tool using filters. The SOE Tools employs a framework of computer controls to navigate and express the data the user wants to display or report. Referring to FIG. 21, the SOE Tool provides 10 different controls at the top of screen shot 2100 which provide mechanisms to allow the user to navigate between the category structures of each data project by merely clicking a button representing the desired category. As shown in FIGS. 22-23, there is provided a seamless interface to transition data to a selected category in whatever display view is active. There is a dropdown list control 2202, 2302 on each of the category level views that provides the ability to select any of the product levels included in the data set for display in the view. The detail view 2300 seen in FIG. 23, a user can use a toggle to move between a retailer summary and a detailed category/segment information view for each retailer. View 2300 also provides a concurrent view of all of a user's brands within the selected category. As is further shown in View 2300, the SOE Tool provides a filtering capability that allows the user to include or restrict any and all of the individual retailers included in the data.

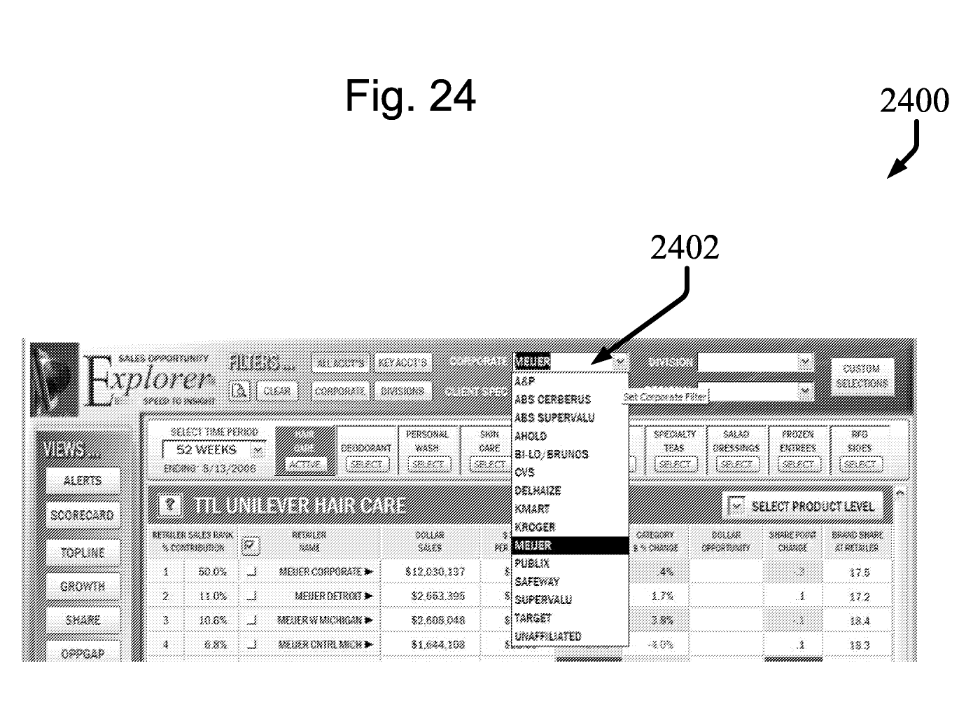

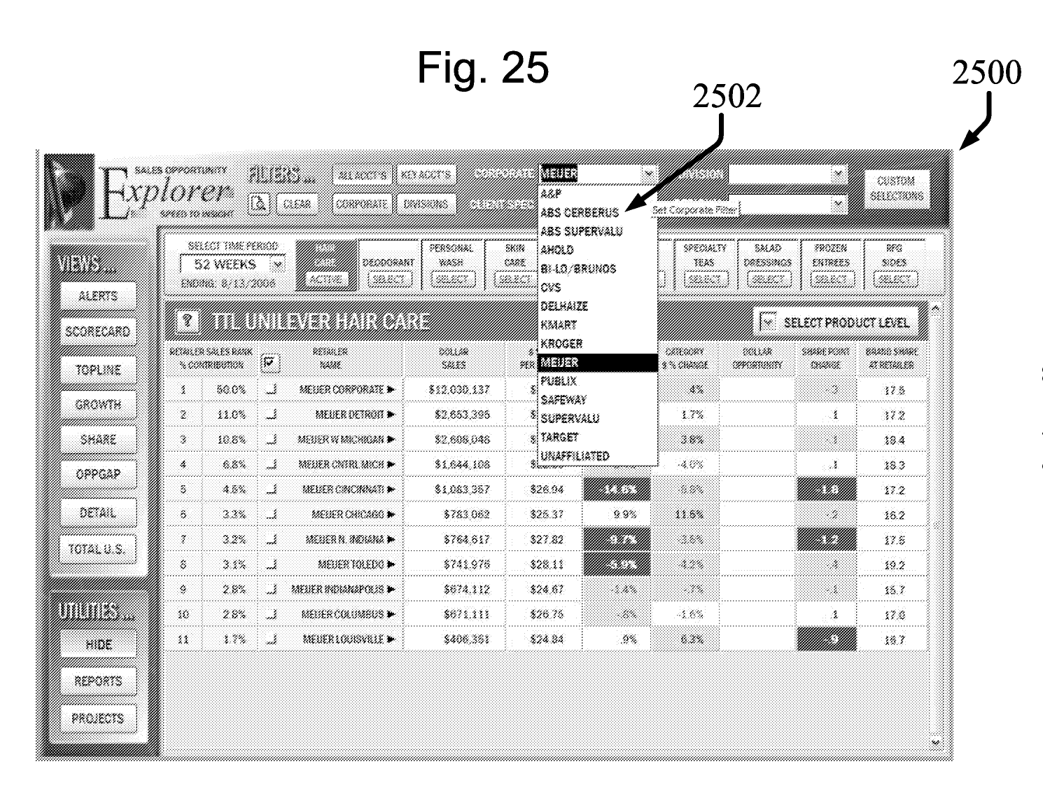

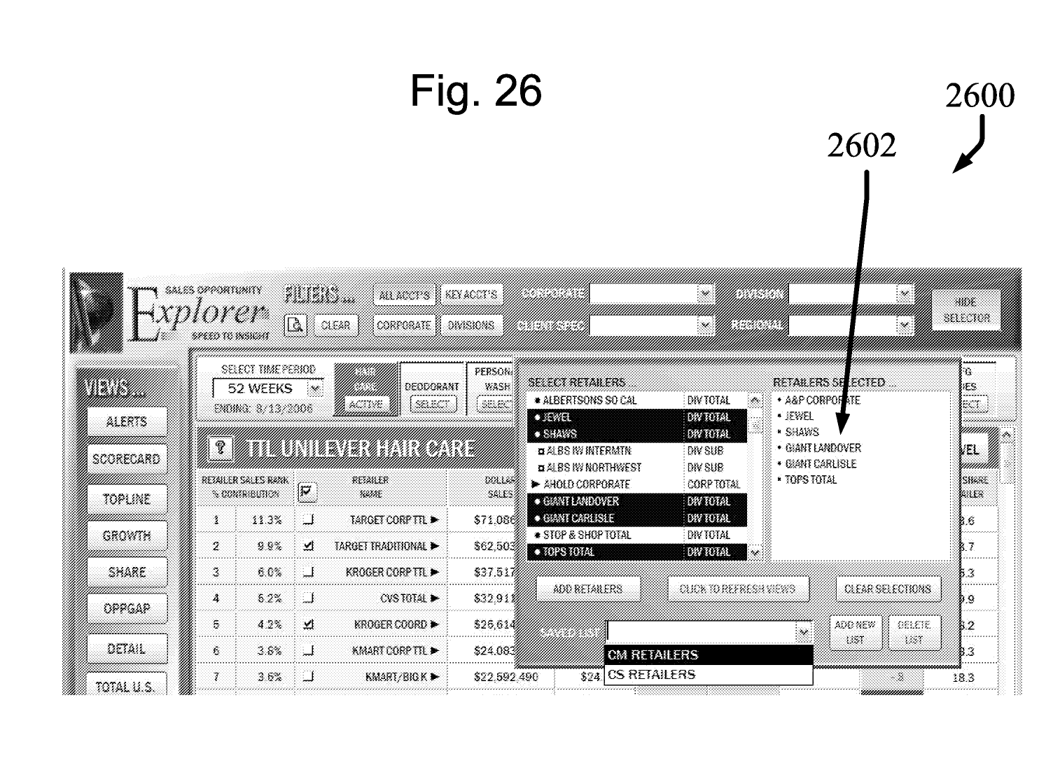

FIGS. 24-26 show, at pull down menu 2402, 2502, 2602 in screen shots 2400-2600, the functionality of filtering that facilitates the rapid response to users to enable them to focus on specific retailers that are germane to the user's areas of responsibility. Retailer filtering capabilities include:
1. All retailers
2. Corporate retailers
3. Divisions of corporate retailers
4. Key non-affiliated retailers
5. Specific corporate retailer and divisions
6. Client specific custom hierarchy
7. ASM internal divisional/regional hierarchy
8. Ad hoc custom retailer grouping capability

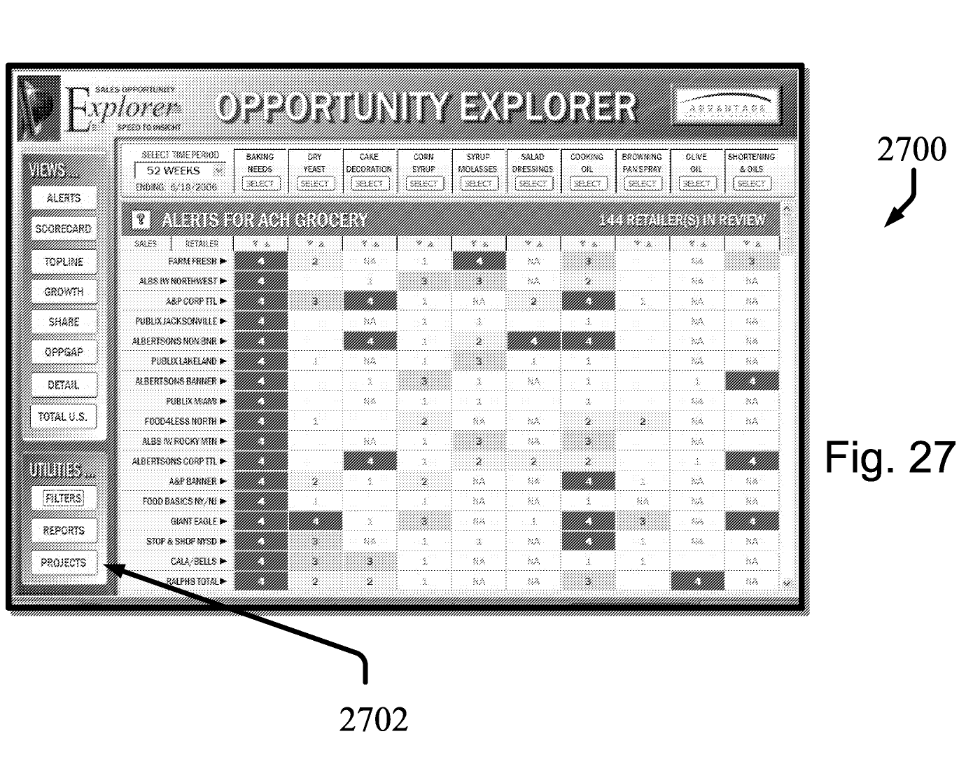

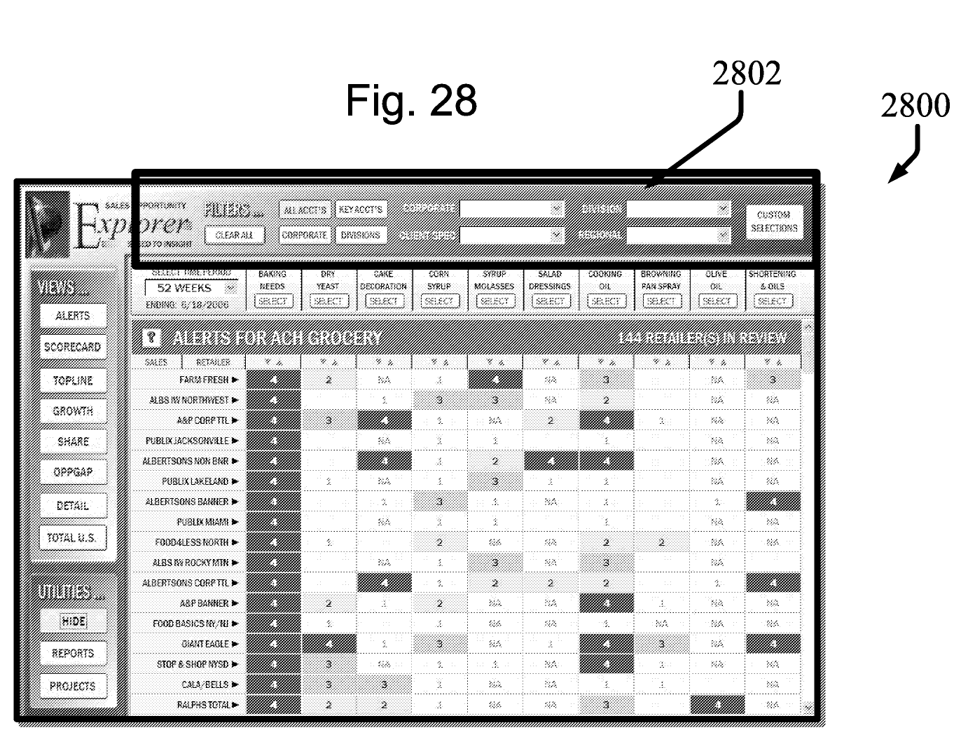

As shown in screen shot 2700 of FIG. 27, the user can utilize the filters capabilities to filter down to specific retailers and geographies. For instance, at 2702, the user can click on the filters button in the utilities menu to access the filters menu. As shown in screen shot 2800 of FIG. 28, the user can utilize the filters menu to open at the top of the SOE Tool to replace the SALES OPPORTUNITY EXPLORER title. At reference numeral 2702 in FIG. 27, the user can close the filters menu by clicking on the “HIDE” button in the “Utilities” menu.

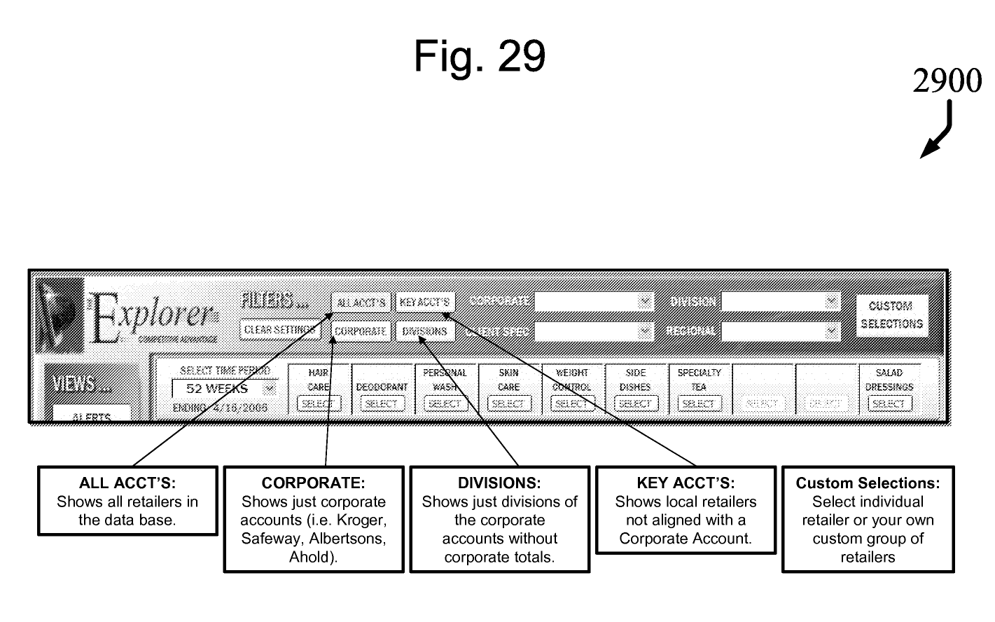

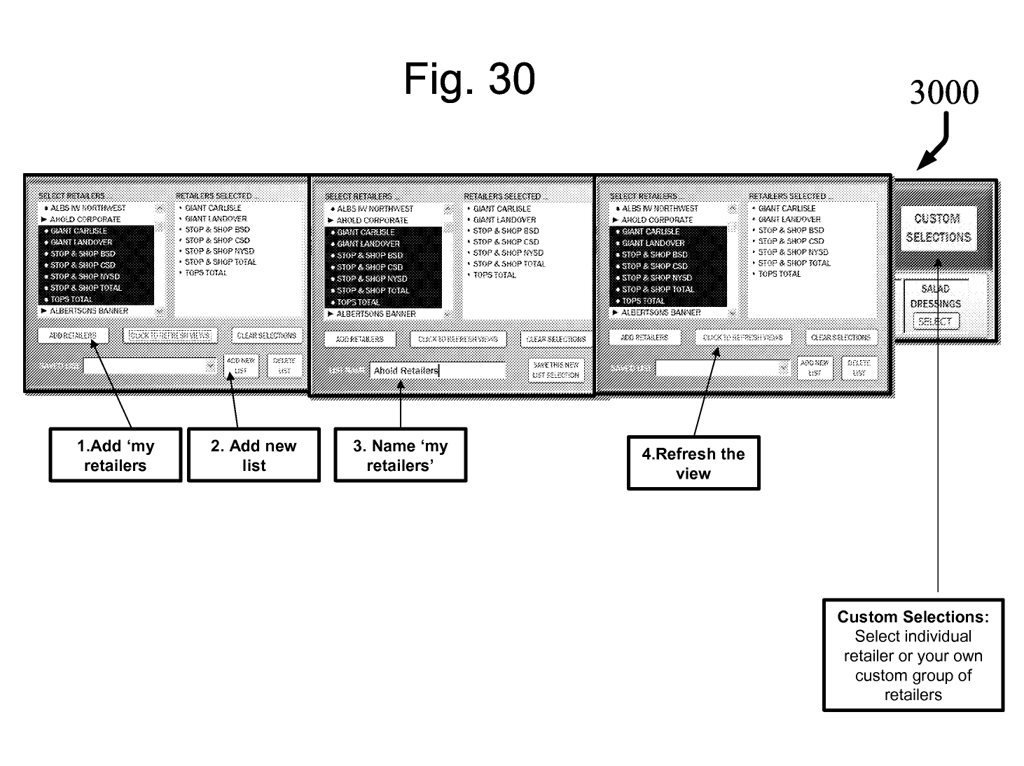

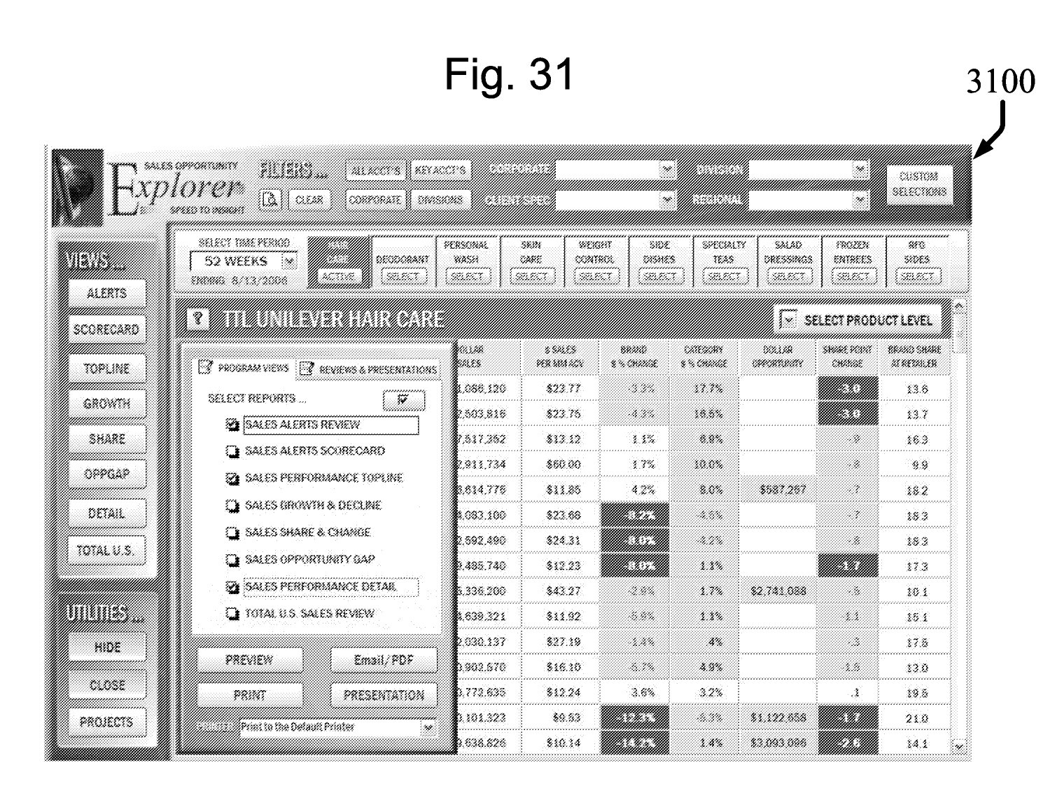

In further explanation of the filtering capabilities of the SOE Tool, FIG. 29 shows a partial screen shot 2900 that features a plurality of drop down menus. These include “Corporate” filters down to a selected corporate retailer and all available divisions; “Retailers” filters down to one selected retailer; “Divisions” filters down to the retailers within the selected business unit; and “Regional” filters down to the retailers within the selected Market geography. FIG. 30 further shows in screen shot 3000 the user's ability to save custom filters. This functionality includes the user's selections of retailers in a particular group, the ability to add new lists of filters, to add a name for a group of retailers, and a way to refresh views and the presently selected retailers.

Referring now to FIG. 31, an exemplary screen shot is shown at reference numeral 3100 in demonstration of the reporting and deployment options of the SOE Tool. The SOE Tool contains a reporting engine that enables the user to select and distribute reports in multiple formats. Each report can be viewed on screen, saved as a printable format (e.g.; portable document format or “PDF”) file, printed, or distributed electronically via e-mail. These options are all controlled from the application's control elements with user friendly easily selectable options.

The following suite of pre-developed and formatted reports are available in a menu organized repository in the application:
1. The views menu provides a report format that mimics each of the data views in the application, and is manipulated identically with the function controls to represent the data displayed in the on-screen view.
2. The presentation menu provides the user with a myriad of pre-formatted and presentation ready reports designed to support all aspects of the business process and sales and management activities.
3. Many of the reports are interactive with the users custom input and provide a seamless mechanism to present the salient business observations and conclusions provided by the user.
4. The reports are automatically adjusted graphically to accommodate a variety of custom logos for both the client and the retailer customers with no user intervention.

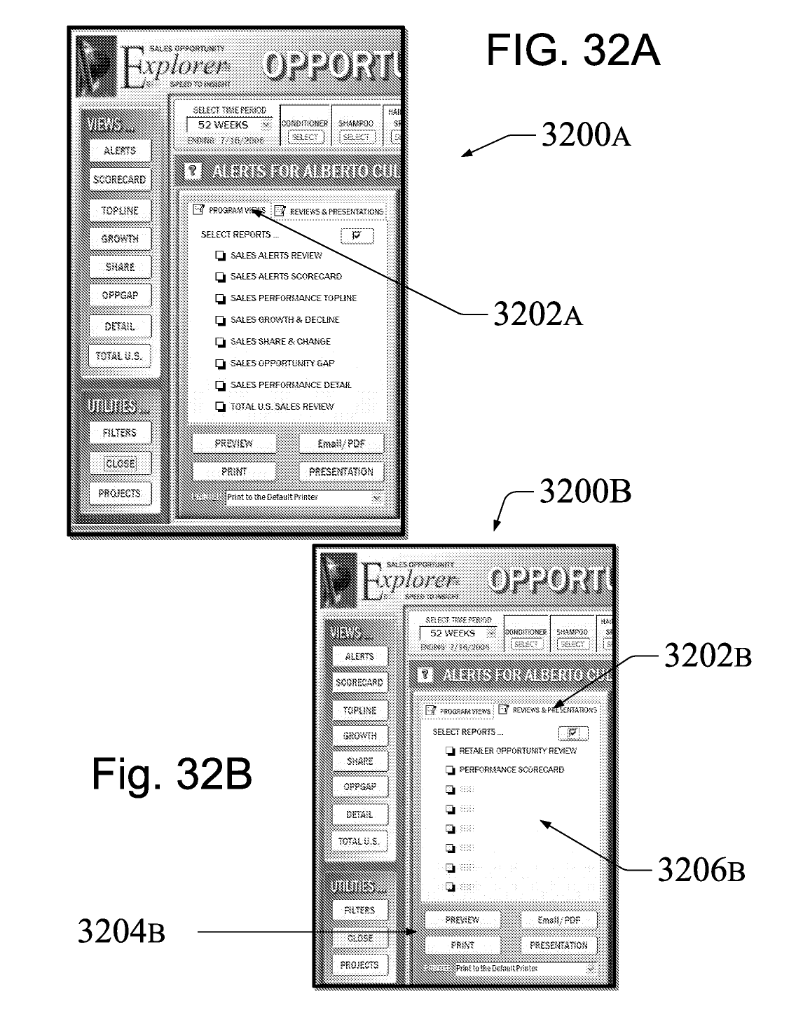

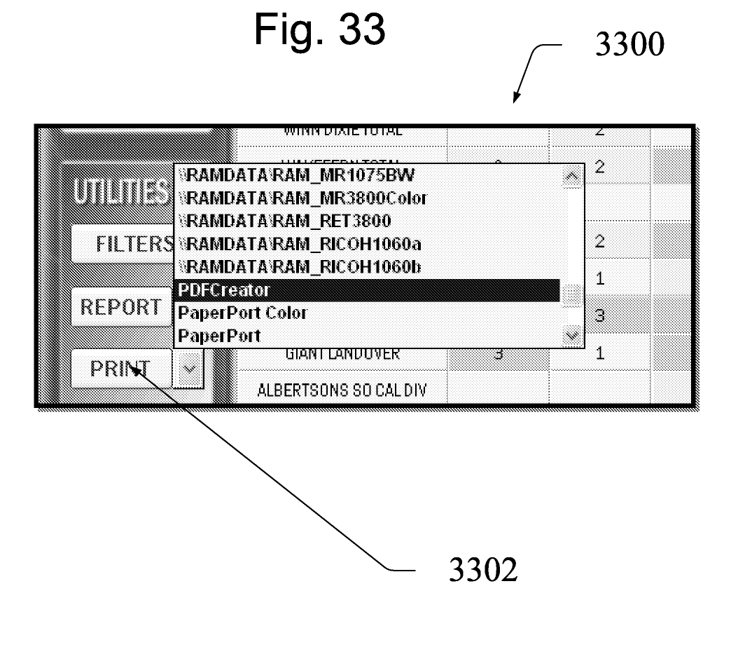

In further explanation of the printing functionality of the SOE Tool, screen shot 3200A in FIG. 32A shows a Program View tab 3202A such that each “View” from the Menu has a printable option, and screen shot 3200B in FIG. 32B shows a “Reviews and Presentations” tab 3202B to indicate that these reports are summary reports designed from the SOE data and that these reports respond to any of the filter options chosen by the user. The newest review Report, Performance Scorecard, section 3206B is seen in screen shot 3200b, which provides the user with a recap of all the client brands across all the product groups in a selected project. A printing options section 3204B is seen in screen shot 3200b, which allows the user to choose to have a report saved to a PDF format and emailed or printed, or the user can choose a printer and send the report directly to then chosen printer. FIG. 33 shows a user interface screen 3300 with a selection option at button 3302 which, when activated, brings up a dialog box 3304 of selectable printers.

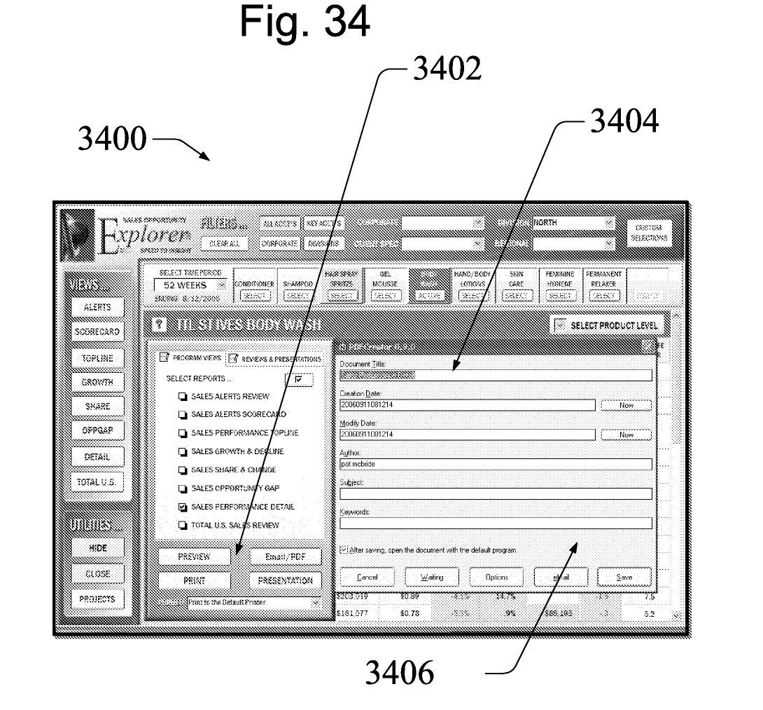

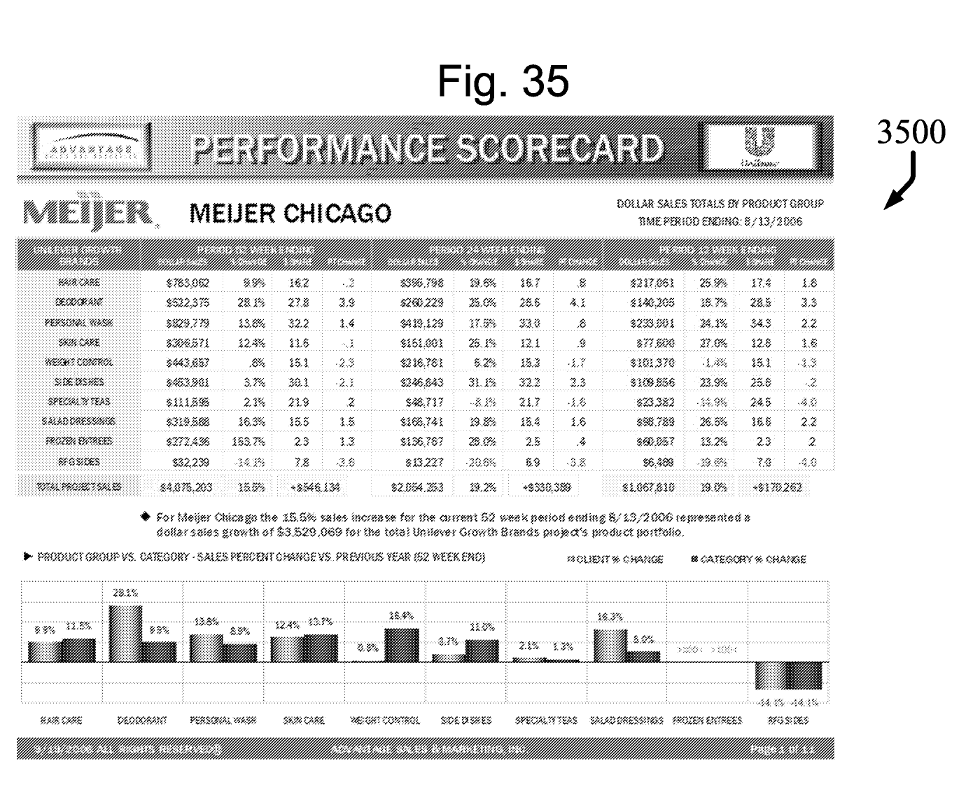

Referring now to FIG. 34, screen shot 3400 provides a user with dialog box for e-mailing report. The functionality exhibited in FIG. 34 includes a section 3402 to send a report by email as a PDF file, a section 3404 for naming a report, and a section 3406 to send the report in an e-mail.

Referring to FIG. 35, a screen shot 3500 presents a performance score card containing exemplary data for the entity “Meijer” across the categories of products in the brand “Unilever”. The report seen in screen shot 3500 can be printed, e-mailed, or rendered as a soft copy by the SOE Tool.

In summary, the emphasis of the SOE Tool is not in the determining or otherwise forecasting of market share, but rather the identifying and prioritizing for its user potential opportunities for additional market share and corrective action. The disclosed SOE Tool is enabled to:
identify, select, and combine the Four Metrics that are to be measured, and then provide a flexible, dynamic, user-directed means of measuring relative performance against the Four Metrics across multiple dimensions of time periods, product lines, and retail outlets (as opposed to providing rigid pre-determined “benchmarks” for the Four Metrics against which sales performance is to be measured);
identify opportunities for improving future sales performance over the performance that would otherwise be forecasted or expected;
dynamically compare a category-brand's sales performance over time with that of competing category-brands and the category-brand's sales performance in a retailer over time with that of competing category-brands' sales performance in other retailers, thereby identifying opportunities for improving future sales performance that would otherwise be missed;
dynamically analyze comparative sales performance at the category, category-brand, or category-brand-item level, within various geographic markets and/or retailers (e.g.; vis-à-vis other stores), for the purpose of identifying opportunities to improve the likely future sales performance of a retail store by its customers that would otherwise be missed;
identify sales opportunities that can be exploited, independent of overall market conditions which would be reflected (more or less accurately) in a forecasting tool, and regardless of whether the market is trending down, is flat or is trending up. These potentials for sales exploitation are identified and prioritized to the user so that they can improve future sales performance over that which would otherwise be expected/forecast;
measure performance dynamically in comparison with the performance of other brands and in other stores, rather than measuring performance against fixed, predetermined benchmark values; just because a business is meeting its predetermined objectives does not necessarily means it is healthy or could not be doing better;
provide understanding and insight, when sales objectives are missed, into strategies for correcting the problem, and the causes of the shortfall;
combine the measurement of multiple threshold conditions in multiple dimensions to highlight areas of urgency and identify the opportunities for action that would provide the greatest return (the “biggest bang for the buck”); and
take the user through an interactive, user-directed sequential process of:
   Identifying alert conditions (both opportunities to exploit sales opportunities and to correct issues in sales performance that should be addressed);
   Understanding and evaluating the opportunities presented by the alert conditions;
   Gaining insight into actions to be taken to exploit/address the opportunities; and
   Communicating the action plans to personnel who can execute upon the alerted opportunities and/or take corrective actions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within meaning and range of equivalency of the claims are to be embraced within their scope.

What is claimed is:

1. A method comprising:
for each for a plurality of criteria within each of a plurality of retailers, wherein the criteria is selected from the group consisting of brands, segments having a plurality of said brands, and categories having a plurality said segments, calculating:
the currency value of sales for the criteria at the retailer for a current time period;
the currency value of sales for the criteria at the retailer for a past time period;
the difference in the currency value of sales for the criteria at the retailer between the current and past time periods;
and
for each said retailer showing a decline in the currency value of sales for the criteria, rendering an alert.

2. The method as defined in claim 1, further comprising, for each said criteria within each said retailer, rendering in an alternative intensity each said alert that is greater than the average of other said alerts.

3. The method as defined in claim 1, further comprising, for each said criteria within each said retailer:
calculating for each said alert the deviation from a predetermined standard; and
rendering each said deviation as a corresponding predetermined intensity.

4. The method as defined in claim 1, further comprising:
ranking, for each said retailer, the number of said alerts for each said criteria; and
rendering the ranked alerts for each said retailer.

5. A method for identifying retailers whose growth in sales for a criteria is underperforming the overall growth in sales for said criteria, comprising:
for each for a plurality of criteria within each of a plurality of retailers, wherein the criteria is selected from the group consisting of brands, segments having a plurality of said brands, and categories having a plurality said segments, calculating:
the percentage change in the currency value of sales for the criteria at the retailer for a current time period as compared with a past time period;
the percentage change in the currency value of sales for the criteria at the retailer for the current time period as compared with the past time period;
the difference between the percentage growth change of sales for the criteria at the retailer and the percentage growth change of sales for the criteria for the plurality of said retailers;
and
for each said retailer whose percentage growth change of sales for the criteria is lower than the percentage growth change of sales for the criteria at the plurality of said retailers, rendering an alert.

6. The method as defined in claim 5, further comprising, for each said criteria within each said retailer, rendering in an alternative intensity each said alert that is greater than the average of other said alerts.

7. The method as defined in claim 5, further comprising, for each said criteria within each said retailer:
calculating for each said alert the deviation from a predetermined standard; and
rendering each said deviation as a corresponding predetermined intensity.

8. The method as defined in claim 5, further comprising for each said criteria, rendering a graphical display showing, from the plurality of said retailers, the relative performance of the 10 said retailers with the worst performance as compared with the change of the criteria, and the relative performance of the 10 said retailers with the best performance as compared with the change of the criteria.

9. The method as defined in claim 5, further comprising for a plurality of said criteria, rendering a graphical display showing, from the plurality of said retailers, the relative performance of the 10 said retailers with the worst performance as compared with the change of the plurality of said criteria, and the relative performance of the 10 said retailers with the best performance as compared with the change of the plurality of said criteria.

10. A method for identifying retailers whose market share of sales for a criteria is declining, the method comprising:
for each for a plurality of criteria within each of a plurality of retailers, wherein the criteria is selected from the group consisting of brands, segments having a plurality of said brands, and categories having a plurality said segments, calculating;
the market share of the currency value of sales for the criteria at the retailer as compared with the currency value of sales for the entire market for the criteria at the plurality of said retailers for a current time period;
the market share of the currency value of sales for the criteria at the retailer as compared with the currency value of sales for the entire market for the criteria at the plurality of said retailers for a past time period; and
the difference in the market share of the currency value of sales for the criteria at the retailer between the current and past time periods;
and
for each said retailer showing a decline in the market share of the currency value of sales for the criteria, rendering an alert.

11. The method as defined in claim 10, further comprising for each said criteria, rendering in an alternative intensity each said alert that is greater than the average of the alerts for the plurality of the retailers.

12. The method as defined in claim 10, wherein the rendering of the alert further comprises:
looking up in a table a predetermined alert intensity that corresponds to the decline in the market share of the currency value of sales for the criteria; and
rendering the alert with the predetermined alert intensity.

13. The method as defined in claim 10, further comprising:
ranking by number the alerts for each said criteria for each said retailer; and
rendering the ranked alerts for each said retailer.

14. The method as defined in claim 10, further comprising rendering a graphical display showing:
for each said criteria for each said retailer:
the market share; and
the change in market share;
for each of the 10 said retailers having the largest decline in market share:
the currency value of sales of the criteria; and
the respective market share; and
for each of the 10 retailers with largest growth in market share:
the change in market share; and
the currency value of sales of the criteria.

15. A method comprising:
for each for a plurality of criteria within each of a plurality of retailers, wherein the criteria is selected from the group consisting of brands, segments having a plurality of said brands, and categories having a plurality said segments, calculating:
the actual currency value of sales for the criteria at the retailer for a time period;
the expected currency value of sales for the criteria at the retailer for the time period that would be achieved if the market share for the criteria at the retailer was equal to the overall market share for the criteria at all said retailers;
the difference, being a sales opportunity gap amount, between the actual currency value of sales for the criteria at the retailer and the expected currency value of sales for the criteria at the retailer;
and
for each said retailer where the actual currency value of sales for the criteria is less than the expected currency value of sales for the criteria, rendering a sales opportunity gap alert.

16. The method as defined in claim 15, rendering in an alternative intensity each said sales opportunity gap alert where the corresponding difference between the actual and expected currency value of sales for the criteria for any said retailer is greater that an average thereof for all said retailers.

17. The method as defined in claim 15, further comprising for each said sales opportunity gap alert:
determining a predetermined alert intensity corresponding to the difference between the actual currency value of sales for the criteria at the retailer and the expected currency value of sales for the criteria at the retailer; and
rendering the sales opportunity gap alert with the predetermined alert intensity.

18. The method as defined in claim 15, further comprising:
ranking, for each said retailer, the number of said alerts for each said criteria; and
rendering the ranked alerts for each said retailer.

19. The method as defined in claim 15, further comprising rendering a graphical display showing:
the total number of said retailers having at least one said sales opportunity gap alert;
the total currency value of the sales opportunity gap amounts for which there was a corresponding said the sales opportunity gap alert; and
the currency value of the sales opportunity gap amount for each of the 10 said retailers having the largest said sales opportunity gap amounts.

20. A computer readable medium comprising instructions which, when executed by a computer, the computer performs the steps of:
(a) for each for a plurality of criteria within each of a plurality of retailers, wherein the criteria is selected from the group consisting of brands, segments having a plurality of said brands, and categories having a plurality said segments, calculating:
the currency value of sales for the criteria at the retailer for a current time period;
the currency value of sales for the criteria at the retailer for a past time period;
the difference in the currency value of sales for the criteria at the retailer between the current and past time periods;
and
for each said retailer showing a decline in the currency value of sales for the criteria, rendering a first alert;
(b) for each for a plurality of criteria within each of a plurality of retailers, wherein the criteria is selected from the group consisting of brands, segments having a plurality of said brands, and categories having a plurality said segments, calculating:
the percentage change in the currency value of sales for the criteria at the retailer for a current time period as compared with a past time period;
the percentage change in the currency value of sales for the criteria at the retailer for the current time period as compared with the past time period;
the difference between the percentage growth change of sales for the criteria at the retailer and the percentage growth change of sales for the criteria for the plurality of said retailers;
and
for each said retailer whose percentage growth change of sales for the criteria is lower than the percentage growth change of sales for the criteria at the plurality of said retailers, rendering a second alert;
(c) for each for a plurality of criteria within each of a plurality of retailers, wherein the criteria is selected from the group consisting of brands, segments having a plurality of said brands, and categories having a plurality said segments, calculating;
the market share of the currency value of sales for the criteria at the retailer as compared with the currency value of sales for the entire market for the criteria at the plurality of said retailers for a current time period;
the market share of the currency value of sales for the criteria at the retailer as compared with the currency value of sales for the entire market for the criteria at the plurality of said retailers for a past time period; and
the difference in the market share of the currency value of sales for the criteria at the retailer between the current and past time periods;
and
for each said retailer showing a decline in the market share of the currency value of sales for the criteria, rendering a third alert;
(d) for each for a plurality of criteria within each of a plurality of retailers, wherein the criteria is selected from the group consisting of brands, segments having a plurality of said brands, and categories having a plurality said segments, calculating:
the actual currency value of sales for the criteria at the retailer for a time period;
the expected currency value of sales for the criteria at the retailer for the time period that would be achieved if the market share for the criteria at the retailer was equal to the overall market share for the criteria at all said retailers;
the difference, being a sales opportunity gap amount, between the actual currency value of sales for the criteria at the retailer and the expected currency value of sales for the criteria at the retailer; and
for each said retailer where the actual currency value of sales for the criteria is less than the expected currency value of sales for the criteria, rendering a fourth alert;
and
(e) for each said retailer:
ranking the corresponding number of each said first, second, third, and fourth alerts; and
rendering the ranked alerts.

21. The computer readable medium as defined in claim 20, wherein each said alert is derived from a data set selected from the group consisting of:
a Point-of-Sale (Sale) data set;
a Retail Audit Data (RAD) data set;
a Consumer Panel Data (CPA) data set; and
a combination thereof.

22. The computer readable medium as defined in claim 20, wherein:
the rendered ranked alerts are visually distinguished according to the corresponding said number of each said first, second, third, and fourth alerts; and
the rendering of the ranked alerts comprises rendering each said ranked alert on a display of an interactive user interface.

23. The computer readable medium as defined in claim 20, wherein the instructions further comprise code which, when executed by the computer, the computer performs the steps of:
interactively permitting the selection of said criteria, each said retailer, and each said time periods; and
forming a transmission containing the rendered ranked alerts.
